(19) United States
(12) Patent Application Publication
(10) Pub. No.: US 2024/0397261 A1
(43) Pub. Date: Nov. 28, 2024

(54) DISTRIBUTING SIGNALS

(71) Applicant: Solid State Logic UK Limited, Oxford (GB)

(72) Inventors: Alan James BOWEN, Bicester (GB); Steven Peter BROWN, Banbury (GB)

(21) Appl. No.: 18/665,350

(22) Filed: May 15, 2024

(30) Foreign Application Priority Data
May 22, 2023 (GB) 2307628.4

(51) Int. Cl. H04R 3/12; G06F 3/16

(52) U.S. Cl. CPC H04R 3/12; G06F 3/162; H04R 2430/01

(57) ABSTRACT

Distributing audio signals from a plurality of audio inputs to a plurality of outputs in response to a user-defined distribution is shown. The user-defined distribution is processed by a layered stack of function matrices, each layer including a two-dimensional array of function nodes. Node functions in a layer are updated in response to user-input signals to implement functionality such as signal masking and signal routing. The user-defined distribution is transformed by processing it through the layered stack to define a transformed distribution. The layered stack facilitates comprehensive mixing facilities on low cost signal processing hardware. The transforming layers include a virtual bus-applying layer to reduce the dimensions of the transformed distribution, minimizing the cost of hardware further.

### CROSS REFERENCE TO RELATED APPLICATIONS

This application claims priority from United Kingdom Patent Application number 2307628, filed on May 22, 2023, the whole contents of which are incorporated herein by reference.

### TECHNICAL FIELD

The present invention relates to distributing audio signals. In particular, it relates to modifying a distribution of multiple audio inputs to multiple audio outputs.

### BACKGROUND OF THE INVENTION

Professional recording studios include a variety of equipment for ensuring the best possible capture of musical performances from musicians. This equipment may include high quality microphones, amplifiers, instruments and a mixing desk. A particular advantage of a well-equipped professional recording studio is the ability to enable musicians to hear themselves clearly during performance. This is typically achieved by the provision of a custom mix of instruments monitored separately on respective pairs of headphones worn by the musicians playing in an ensemble. Each such custom headphone monitor mix usually provides the respective musician with a higher level of their own instrument or voice compared to the mix provided to other musicians, thus enabling details of their own performance to be carefully monitored and adjusted by application of musical technique. In a large ensemble, separate mixes may be provided such that, for example, a drummer and bass player have one mix, a vocalist and other musicians another mix, and so on.

As music recording and production has increasingly been performed using digital equipment, much of the physical electronics of a recording studio has been replaced by one or more applications running on a personal computer, thereby enabling professional quality recordings to be made more flexibly and at a lower cost. Instrument or microphone input to the computer is facilitated by an audio interface, which converts analog electrical signals into streams of digital samples. Such audio interfaces often have two, four, eight or more channels of high-quality analog-to-digital conversion that enable multichannel performances to be captured and recorded using a digital audio workstation (DAW) application running on a personal computer. The audio interface typically has a single headphone output for monitoring the inputs. Such an arrangement can work reasonably well when only one or two musicians are performing at a time and can share the same headphone mix.

When multiple musicians require custom monitor mixes on their headphones, such mixing can be performed in the DAW application running on the personal computer, with the resulting outputs being supplied to the musicians via the output channels of the audio interface and an additional headphone amplifier. In this scenario, the general-purpose multitasking operating system (OS) running on the personal computer imposes a delay on live audio signal processing. This delay, known as audio latency, is caused by the computer's processor performing task switching at a relatively low rate in order to provide general purpose computing with reasonable efficiency. Latency in a multitasking general-purpose OS can be minimized by various strategies, but it is extremely difficult to reduce this unwanted delay to less than about five milliseconds. While musicians can, and often do, work with this limitation, it is not ideal, and it would not be considered acceptable in a professional recording environment.

Another solution to the provision of separate mixes to multiple performing musicians is to use an additional analog or digital mixer. This additional piece of equipment adds to the cost and complexity of recording and takes up significant physical space. Use of an additional mixer is accepted in professional recording studios where the equipment is handled by experienced personnel, but the opportunity to record an ensemble at professional quality using a smaller amount of equipment can be lost due to these significant technical requirements.

Additional components can be added to an audio interface to facilitate the provision of multiple custom monitor mixes. Such components include switches and rotary controls such as potentiometers or rotary encoders, along with analog or digital processing circuitry to generate multiple monitor mixes. However, these components add significantly to the cost of the hardware. When considering professional quality recording standards, such components can be prohibitively expensive, and their functionality better implemented using a separate mixing console.

### BRIEF SUMMARY OF THE INVENTION

According to a first aspect of the present invention, there is provided a system for distributing audio signals from a plurality of audio inputs to a plurality of audio outputs, comprising an interface for generating user input signals in response to user input and one or more processors configured to distribute the audio signals from the audio inputs to the audio outputs in response to a user-defined distribution and a plurality of function matrices stored in the memory of the one or more processors, each function matrix comprising a two-dimensional array of function nodes and each function matrix being a layer in a respective third dimension in a transforming stack of the function matrices, the one or more processors being configured to distribute the audio signals by establishing a transformed distribution by processing the user-defined distribution through the layers of the transforming stack, receiving user input signals for a requested change in distribution of the audio inputs to the audio outputs and identifying a modifying request in the user input signals, modifying at least one of the function matrices in response to the modifying request, updating the transformed distribution by processing a gain factor through at least one layer of the transforming stack in response to the modification, and distributing the audio signals from the audio inputs to the audio outputs in response to the updated transformed distribution.

Preferably the one or more processors is configured for updating the transformed distribution by propagating a changed condition through the transforming stack to the transformed distribution in response to the modification and updating the transformed distribution by processing a gain factor through at least one layer of the transforming stack in response to the propagated condition.

Preferably the one or more processors is configured by a first function matrix in a first layer of the transforming stack to reduce at least one dimension of the transforming stack by combining outputs from function nodes of a function matrix in a second layer of the transforming stack.

According to a second aspect of the present invention, there is provided a method of distributing audio signals from a plurality of audio inputs to a plurality of audio outputs in response to a user-defined distribution and a plurality of function matrices, each function matrix comprising a two-dimensional array of function nodes and each function matrix being a layer in a respective third dimension in a transforming stack of the function matrices, the method comprising establishing a transformed distribution by processing the user-defined distribution through the layers of the transforming stack, receiving user input signals for a requested change in distribution of the audio inputs to the audio outputs and identifying a modifying request in the user input signals, modifying at least one of the function matrices in response to the modifying request, updating the transformed distribution by processing a gain factor through at least one layer of the transforming stack in response to the modification, and distributing the audio signals from the audio inputs to the audio outputs in response to the updated transformed distribution.

Preferably the transformed distribution is updated by propagating a changed condition through the transforming stack to the transformed distribution in response to the modification and updating the transformed distribution by processing a gain factor through at least one layer of the transforming stack in response to the propagated condition.

Preferably the method further includes processing a plurality of distribution gains through a function matrix in a first layer of the transforming stack to reduce at least one dimension of the transforming stack by combining outputs from function nodes of a function matrix in a second layer of the transforming stack.

According to a third aspect of the present invention, there is provided a method of distributing audio signals from a plurality of audio inputs to a plurality of audio outputs in response to a layered stack of function matrices, each function matrix comprising a two-dimensional array of function nodes, comprising updating node functions in a layer of the stack in response to user input signals, transforming a user-defined distribution by processing it through the layered stack to define a transformed distribution, and supplying the transformed distribution for audio signal distribution.

Preferably the method further includes reducing a dimension of the user-defined distribution in response to a dimension-reducing layer in the stack.

Preferably, changes to the gains of the transformed distribution are masked by a layer in the transforming stack.

Preferably gains of the transformed distribution are updated in response to propagated changes.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 shows an environment for recording musical performances, including an audio interface, a laptop computer with a display, a user and an SD card;

FIG. 2 details steps performed by the user shown in FIG. 1 when recording musical performances on the laptop computer shown in FIG. 1, including a step of running virtual mixer instructions on the laptop shown in FIG. 1 and a step of running firmware on the audio interface shown in FIG. 1;

FIG. 3 details the step of executing the virtual mixer instructions shown in FIG. 2;

FIG. 4 shows a view of the virtual mixer application on the laptop display shown in FIG. 1, including an input channel, a talkback channel, a playback channel and output channels;

FIG. 5 details the input channel shown in FIG. 4;

FIG. 6 details the talkback channel shown in FIG. 4;

FIG. 7 details the playback channel shown in FIG. 4;

FIG. 8 details the output channels shown in FIG. 4;

FIG. 9 details the control surface of the audio interface shown in FIG. 1;

FIG. 10 details hardware components of the audio interface shown in FIG. 1, including serial flash memory and random-access memory (RAM);

FIG. 11 details contents of the serial flash memory shown in FIG. 10;

FIG. 12 details contents of the RAM shown in FIG. 10, including distribution instructions, audio input and output samples and layers including a user-defined distribution, an after-fade listen (AFL) masking layer, direct masking layers, a re-dimensioning layer and a transformed distribution;

FIG. 13 details the audio input and output samples shown in FIG. 12;

FIG. 14 details signal flow for a user-defined distribution of the audio samples shown in FIG. 12, including pre-processing stages, post-processing stages and finalizing stages;

FIG. 15 details a pre-processing stage of the kind shown in FIG. 14;

FIG. 16 details a post-processing stage of the kind shown in FIG. 14;

FIG. 17 details a finalizing stage of the kind shown in FIG. 14;

FIG. 18 details steps performed by the distribution instructions shown in FIG. 12, including a step of updating a layer shown in FIG. 12, a step of transforming the user-defined distribution shown in FIG. 12, and a step of distributing audio signals;

FIG. 19 shows a geometrical representation of the layers shown in FIG. 12 in an initial state;

FIG. 20 details the step of updating a layer shown in FIG. 18, including a step of updating the user-defined distribution shown in FIG. 12, a step of updating the AFL masking layer shown in FIG. 12 and a step of updating a direct masking layer of the type shown in FIG. 12;

FIG. 21 details the step of updating the user-defined distribution shown in FIG. 20, including a step of marking a node as changed;

FIG. 22 illustrates the effect of the step of updating the user-defined distribution shown in FIG. 20;

FIG. 23 details the step of updating an AFL masking layer shown in FIG. 20, including selecting an AFL activation pattern, selecting an AFL deactivation pattern and a step of marking a node as changed;

FIG. 24 details the AFL activation pattern selected in FIG. 23;

FIG. 25 details the AFL deactivation pattern selected in FIG. 23;

FIG. 26 details the step of updating the direct masking layer shown in FIG. 20, including selecting a direct activation pattern, selecting a direct deactivation pattern and a step of marking a node as changed;

FIG. 27 details a first kind of direct activation pattern of the type selected in FIG. 23;

FIG. 28 details a first kind of direct deactivation pattern of the type selected in FIG. 23;

FIG. 29 details a second kind of direct activation pattern of the type selected in FIG. 23;

FIG. 30 details a second kind of direct deactivation pattern of the type selected in FIG. 23;

FIG. 31 details the step of marking a node as changed shown in FIGS. 21, 23 and 26, including a step of identifying dependent nodes;

FIG. 32 details the step of identifying dependent nodes shown in FIG. 31, including a step of identifying dependent nodes using a mapping for the re-dimensioning layer shown in FIG. 12;

FIG. 33 details the step of identifying dependent nodes using a mapping for the re-dimensioning layer shown in FIG. 32;

FIG. 34 illustrates the effect of the step of identifying dependent nodes using a mapping for the re-dimensioning layer shown in FIG. 32;

FIG. 35 illustrates the effect of marking a node as changed shown in FIGS. 21, 23 and 26;

FIG. 36 details the step of transforming a user-defined distribution shown in FIG. 18, including a step of fetching a value for a node;

FIG. 37 details the step of fetching a value for a node shown in FIG. 36, including a step of getting a value from a re-dimensioning layer and a step of getting a value from a masking layer;

FIG. 38 details the step of getting a value from a re-dimensioning layer shown in FIG. 37;

FIG. 39 details the step of getting a value from the masking layer shown in FIG. 37;

FIG. 40 illustrates the effect of the steps shown in FIG. 18;

FIG. 41 details the transformed distribution shown in FIG. 12;

FIG. 42 details the step of distributing audio signals shown in FIG. 18;

FIG. 43 details hardware components of the laptop computer shown in FIG. 1, including a processor and RAM;

FIG. 44 details contents of RAM shown in FIG. 33 for an alternative embodiment, including virtual mixer instructions and layers that include a master volume layer;

FIG. 45 details steps performed by the virtual mixer instructions shown in FIG. 44, including an embodiment of the step of transforming a user-defined distribution previously detailed in FIG. 36, but using instructions executed by the processor shown in FIG. 43, and including a step of serialization;

FIG. 46 details steps performed by the processor shown in FIG. 43 when propagating the user-defined distribution shown in FIG. 44 through the master volume layer shown in FIG. 44;

FIG. 47 details the steps performed by the audio interface shown in FIG. 1 when executing the distribution instructions shown in FIG. 12 in accordance with an alternative embodiment; and

FIG. 48 illustrates a further alternative embodiment in which the serialization step detailed in FIG. 45 is performed by a serialization layer.

### DETAILED DESCRIPTION OF EMBODIMENTS OF THE INVENTION

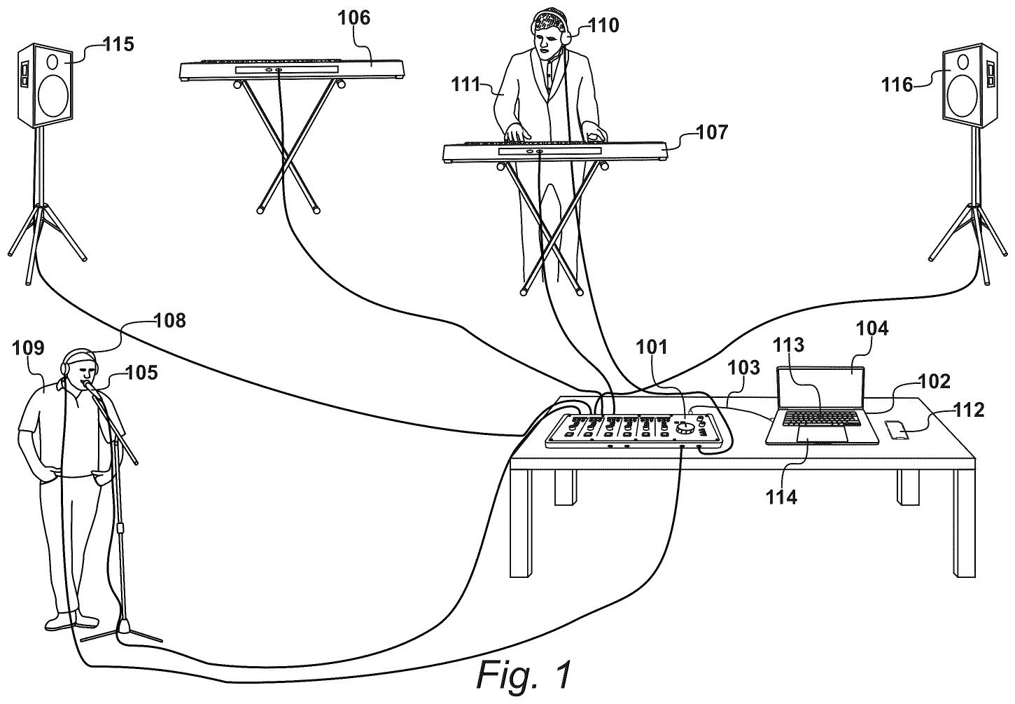

### FIG. 1

An environment for recording musical performances is shown in FIG. 1. An audio interface 101 is connected to a laptop computer 102 via a Universal Serial Bus (USB) connection 103. The laptop 102 provides a Graphical User Interface (GUI) shown on its display 104. The audio interface 101 has a small number of physical switches, sliders and other external controls, thereby minimizing its cost while simultaneously increasing its reliability. The audio interface 101 receives analog audio signals from a microphone 105, and keyboards 106 and 107, and can receive up to eight physically connected inputs simultaneously. The audio interface 101 also provides a stereo output to a first pair of headphones 108 worn by a first musician 109 who is the primary user of the laptop computer 102 during the recording of musical performances. The audio interface 101 provides an additional separately mixed stereo output to a second pair of headphones 110 worn by a second musician 111 who plays keyboards 106 and 107. The first pair of headphones 108 is supplied with a mix different to that supplied to the second pair of headphones 110, thereby providing the two performers with the ability to preferentially monitor their own performances while these are being simultaneously recorded.

An issue with known audio interfaces is that the provision of individual mixes to respective performing musicians 109 and 111 is usually facilitated by one of two methods. In the first method, Digital Audio Workstation (DAW) instructions, running on the laptop 102, perform mixing of various audio signals, including live signals from the microphone 108 and keyboards 106 and 107. However, the Operating System (OS) running on the laptop 102 imposes a delay on live audio signals supplied to headphones such as headphones 108 and 110. This delay is known as audio latency and is caused by the laptop's processor switching between tasks every few milliseconds. The laptop's processor does this to provide an efficient multitasking environment. In practice, it is extremely difficult to reduce this latency to less than about five milliseconds when running a general-purpose OS on the laptop 102.

A second solution to the provision of separate mixes to the musicians 109 and 111 is to use an additional analog or digital mixer, thereby avoiding the problem of audio latency imposed by the laptop 102. Such additional equipment adds significantly to the complexity and cost of recording. A variant of this solution is to combine the controls and components of the mixer in an audio interface. However, this significantly increases the cost of the audio interface and reduces its reliability due to the increased number of moving parts, such as switches and potentiometers, that would be required. While such solutions are known, the quality of processing they provide is compromised by the need to keep their cost and complexity within reasonable bounds. As a result, known systems cannot provide the ideal combination of low latency, low cost and high-quality recording.

By contrast, the audio interface shown in FIG. 1 provides separate mixes to the musicians without audible latency and without additional physical mixer controls, allowing the musicians 109 and 111 to concentrate their efforts on musical performance. Instead, mixer controls are provided by the GUI shown on the laptop's display 104. The amount of equipment required is kept to a minimum, keeping costs and setup times low, and providing considerable flexibility in choosing a convenient location for recording. Executable firmware instructions are installed on the audio interface 101 from the Internet via the laptop 102. Alternatively, instructions may be installed from an SD card 112 onto the laptop 102 and from there onto the audio interface 101. User input to the laptop 102 is provided by a keyboard 113 and touchpad 114, as well as a small number of physical switches and controls on the audio interface 101.

While playing back a recording, loudspeakers 115 and 116 can be used as an alternative to headphones 108 and 110. The loudspeakers include their own power amplifiers and can be connected directly to the main monitor output of the audio interface 101.

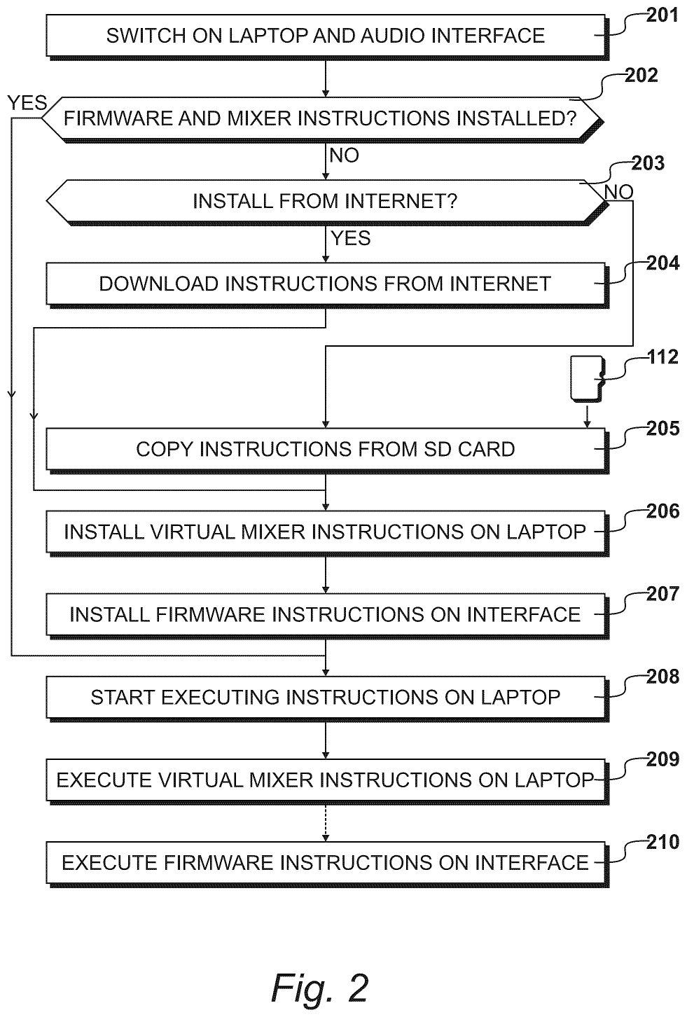

### FIG. 2

The first musician 109 shown in FIG. 1 is also the primary user of the laptop 102. Steps carried out by the user 109 of the laptop 102 shown in FIG. 1 are summarized in FIG. 2. At step 201 the laptop 102 and audio interface 101 are switched on. Power is supplied to the audio interface 101 via the USB cable 103, thereby minimizing the number of cables required while simultaneously maximizing equipment reliability. At step 202, a question is asked as to whether firmware for the audio interface 101 and virtual mixer instructions for the laptop 102 are installed. If not, at step 203 a question is asked as to whether instructions should be installed from the Internet. If so, at step 204, instructions are downloaded from the Internet. Alternatively, instructions are copied from the SD card 112 at step 205.

At step 206, the downloaded or copied virtual mixer instructions are installed on the laptop 102 and at step 207 the downloaded or copied firmware instructions are installed on the audio interface 101. If installation is not required, steps 203 to 207 are skipped. At step 208, Digital Audio Workstation (DAW) instructions are executed on the laptop 102. Suitable DAW instructions are ProTools™ instructions, which will be used to record performances of the musicians 109 and 111. The embodiment is equally capable of operating with other DAW instructions including Ableton Live™, Apple Logic Pro™ and many others according to the preference of the musicians 109, 111.

At step 209 virtual mixer instructions are executed on the laptop 102, and continue executing as step 210 is performed, in which firmware instructions are executed by the audio interface 101.

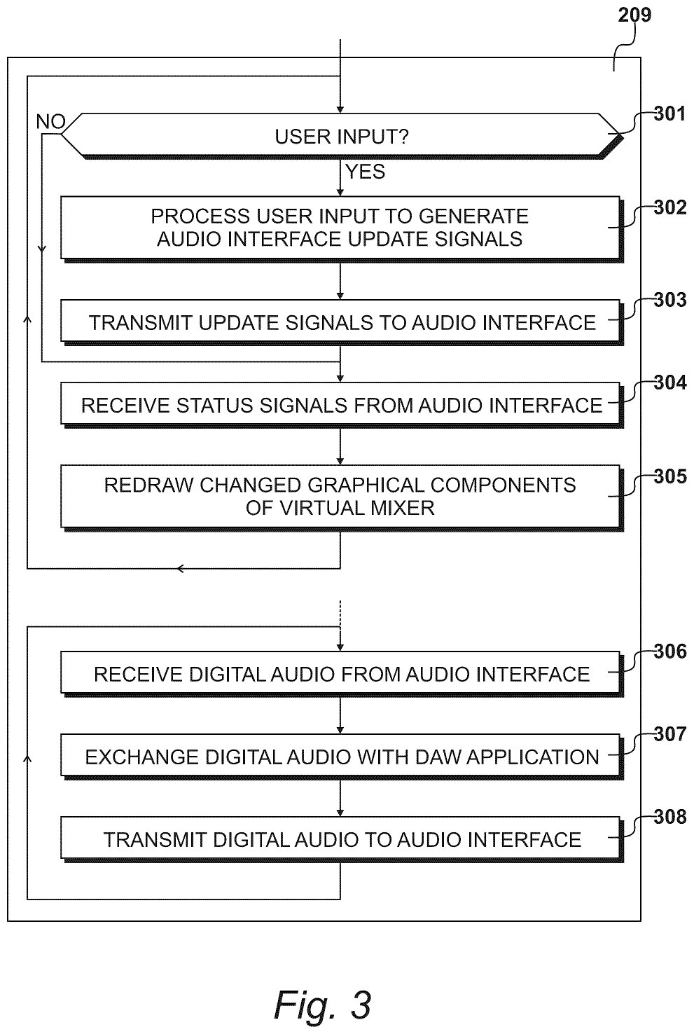

### FIG. 3

The step 209 of executing virtual mixer instructions on the laptop 102 shown in FIG. 2 is detailed in FIG. 3. Virtual mixer instructions facilitate user interaction with the mixing capabilities of the audio interface 101, and these steps are executed on the laptop 102 in order to minimize the number of physical switches, sliders and other controls that must be provided on the audio interface 101, thereby minimizing its cost and maximizing its reliability.

At step 301 a question is asked as to whether any user input relevant to mixing has taken place on the laptop 102. User input is provided using the keyboard 113 and touchpad 114 of the laptop 102. At step 302 any relevant user input is processed to generate update signals for the audio interface 101. At step 303 update signals are transmitted to the audio interface. If no user input has taken place, steps 302 and 303 are skipped. At step 304 status signals are received from the audio interface 101. Status signals include signals from physical switches and controls on the audio interface 101. At step 305 graphical components of the virtual mixer are redrawn on the laptop's display 104. Steps 301 to 305 are repeated until the user 109 closes the virtual mixer application running on the laptop 102.

Simultaneously with steps 301 to 305, digital audio processing is performed at steps 306 to 308. At step 306, digital audio samples are received from the audio interface 101. Due to limitations of the speed of task switching in the general-purpose operating system (OS) running on the laptop 102, a large number of samples are received for each audio input channel. The actual number of samples per channel received for processing at one time is typically more than one hundred. At step 307, the received digital audio samples are exchanged with the DAW instructions that were started at step 208 in FIG. 2. At step 308 digital samples from the DAW are transmitted back to the audio interface, subject to the audio latency imposed by the need to process samples in large batches of a hundred or more per channel. Steps 306 to 308 illustrate the point at which audio latency is introduced if the DAW application were to be used for generating headphone mixes in which the musicians 109, 111 hear themselves while playing. In the embodiment, the DAW is used only for recording, and for listening to tracks that have already been recorded. These tracks may be played back while the musicians 109, 111 are overdubbing new tracks.

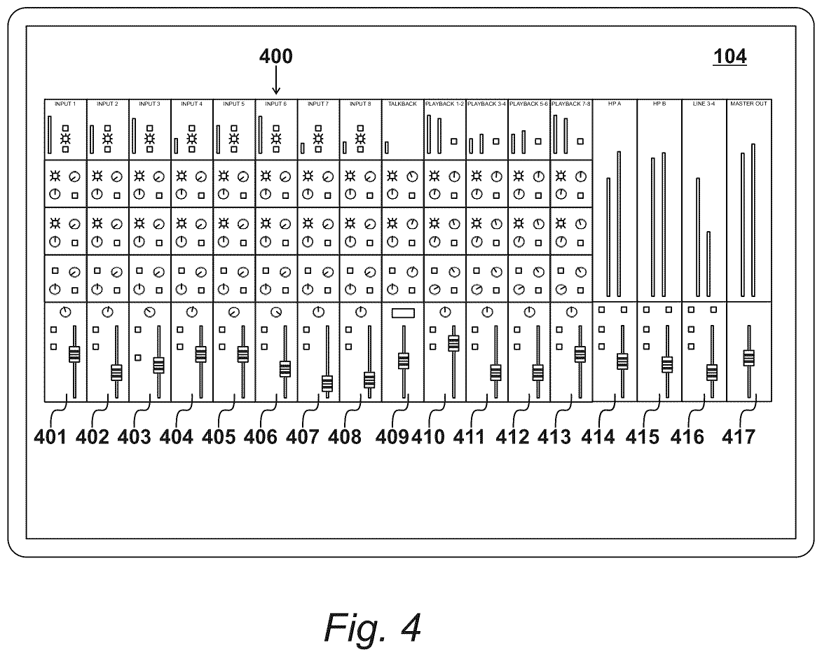

### FIG. 4

Graphical elements of the virtual mixer rendered on the display 104 of the laptop computer 102 shown in FIG. 1 are detailed in FIG. 4. The virtual mixer 400 includes eight analog input channels 401 to 408, a talkback channel 409, four stereo playback channels 410 to 413, and four stereo analog output channels 414 to 417. The first stereo output channel 414 controls the headphone output for the first pair of headphones 108 shown in FIG. 1. The second stereo output channel 415 controls the headphone output for the second pair of headphones 110. The main stereo output channel 417 controls the monitor level in the loudspeakers 115, 116. Different levels from each of the input channels represented graphically as 401 to 408 can be supplied independently to each of the first and second headphone channels 414 and 415, the main stereo output 417, and an auxiliary channel 416.

The virtual mixer 400 shown on the laptop display 104 provides an interface for establishing a user-defined distribution of audio signals between analog inputs and analog outputs physically present on the audio interface 101; including outputs for the headphones 108, 110. However, in order to avoid the issue of audio latency, the distribution of the audio signals is performed by the audio interface 101 in accordance with the user-defined distribution established using the GUI of the virtual mixer 400 provided by the laptop 102 and by a small number of physical switches and controls on the audio interface 101.

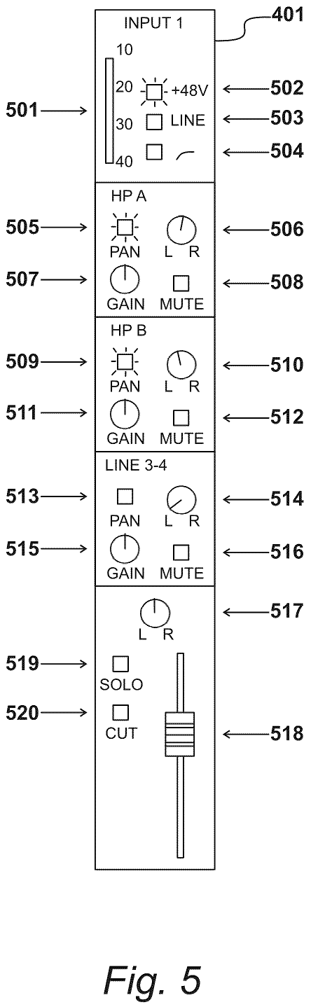

### FIG. 5

The virtual mixer input channel 401 shown in FIG. 4 is detailed in FIG. 5. An input level meter 501 provides an indication of levels supplied to an analog-to-digital converter in the audio interface 101. A phantom power switch 502 is used to activate a forty-eight-volt low current power supply used by the microphone 105. A line input switch 503 selects microphone level or line level input to the audio interface 101. A high pass filter (HPF) switch 504 activates or deactivates a high pass filter.

Controls for defining the level of the microphone 105 to the first pair of headphones 108 include a pan switch 505 that, when activated, causes the microphone 108 to be balanced left-to-right in the headphones 108 in accordance with a pan control 506. If the pan switch 505 is not activated, the left-to-right balance of the microphone 108 will be determined by the channel's main pan control, located further below. The level of the microphone 105 sent to the first pair of headphones 108 is determined by a gain control 507. The microphone 105 can be conveniently muted in the headphones 108 by a mute button 508.

Similar controls are provided for defining the level of the microphone 105 supplied to the second pair of headphones 110. These controls include a pan switch 509, pan 510, gain 511 and mute 512 controls.

The audio interface 101 has an auxiliary stereo output, which can be used for sending the signal from the microphone 105 to a hardware effects unit, such as a reverb or an additional pair of loudspeaker monitors. This auxiliary output has controls that include a pan switch 513, pan 514, gain 515 and mute 514 which operate in the same way as the headphone controls previously described.

The left-to-right balance of the microphone 105 in the loudspeakers 115 and 116 is set by a pan control 517, and the level is set by a slider 518. However, during recording, headphones alone may be used, as this avoids feedback from loudspeakers 115, 116 to the microphone 105. A solo button 519 makes it possible to quickly select the input channel 401 for solo listening on the loudspeakers 115, 116, while muting all other channels, except those which also have their respective solo buttons activated. This solo functionality may also be described as After-Fade Listen (AFL), because the channel's solo level is controlled by its respective fader 518. A cut button 520 can be used to silence the microphone in the loudspeakers, without affecting headphone or auxiliary output levels.

Input channels 402 to 408 have the same appearance as input channel 401 and contribute to a user-defined distribution of the analog inputs of the audio interface 101. Input channels 402 and 403 provide left and right inputs respectively from the first keyboard 106. Input channels 404 and 405 provide left and right inputs from the second keyboard 107.

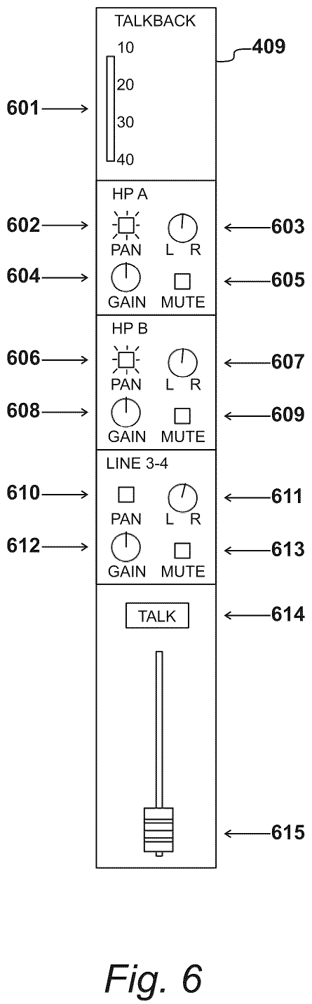

### FIG. 6

The talkback channel shown in FIG. 4 is detailed in FIG. 6. The audio interface 101 includes a small on-board microphone which can be used to communicate with the musicians 109, 111 when they're wearing headphones. The talkback channel 409 has an input level meter 601 that shows the microphone's input level as received by the talkback analog-to-digital converter in the audio interface 101. Like the input channel 401, the talkback channel has controls 602 to 613 that set the level and pan position in the headphones 108, 110 and on the stereo auxiliary channel. A talk button 614 activates the talkback microphone, which is normally switched off. A fader 615 sets the level of talkback in the loudspeakers 115, 116, and this is usually set to a low level, to avoid feedback when the talk button 614 is activated.

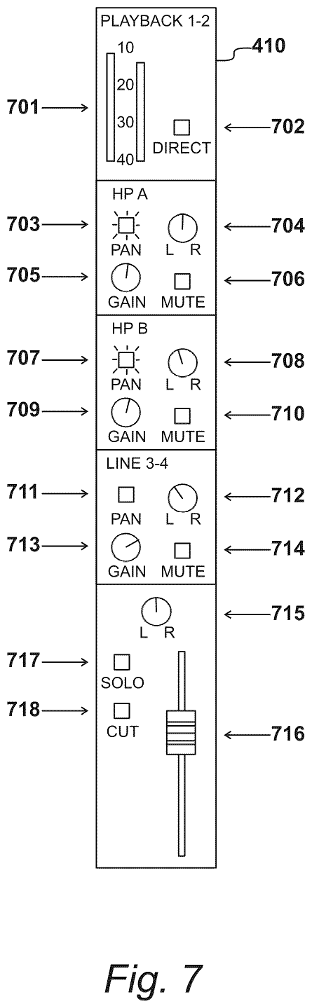

### FIG. 7

The playback channel 410 shown in FIG. 4 is detailed in FIG. 7. The playback channel 410 controls levels received from the DAW application 208 that is being used for recording. Each channel controls a stereo pair. A stereo level meter 701 indicates levels received from the DAW 208. A direct toggle switch 702 can be activated to directly send the playback stereo pair to the main stereo output of the audio interface 101, bypassing the virtual mixer 400. Controls 703 to 714 determine levels sent to headphones 108, 110 and the auxiliary outputs. A pan control 715 sets the left-to-right balance on the loudspeakers 115, 116, and the level to the loudspeakers is set by a fader 716. A solo button 717 provides AFL functionality as described for the input channel 401 shown in FIG. 5. A cut button 718 facilitates silencing of the playback channel pair.

Other playback channels operate similarly. However, the direct switch 702 in the context of the second stereo playback channel 411 directly sends the stereo pair from the DAW 208 to the auxiliary outputs (numbered 3 and 4) of the audio interface 101, rather than the main outputs. Similarly, playback channel 412 will send to the first pair of headphones 108 when its direct switch 702 is activated. Playback channel 413 will send to the second pair of headphones 110 when its direct switch 702 is activated.

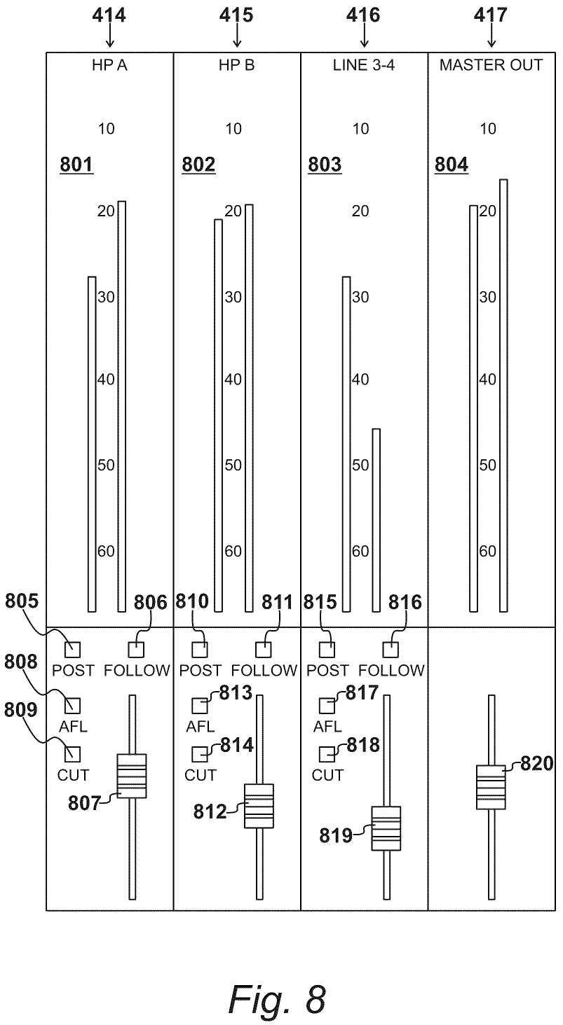

### FIG. 8

The output channels 414 to 417 shown in FIG. 4 are detailed in FIG. 8. Channel 414 is the output channel for the first pair of headphones 108. Channel 415 is the output channel for the second pair of headphones 110. Channel 416 is the stereo auxiliary output, and channel 417 is the master output which supplies the loudspeakers 115 and 116. Each output channel 414 to 417 has a respective stereo level meter 801 to 804 that indicates left and right output levels for the stereo pair. Output channel 414 has a post switch 805, which, when activated, causes the levels supplied from the input channels to be affected by the respective channel's fader 518. Output channel 414 also has a follow switch, that can be used to obtain signals from the main output channel 417 rather than the mix defined for the headphones 108. A fader 807 sets the level. An AFL switch 808 allows the mix for the headphones 108 to be heard on the loudspeakers 115 and 116. A cut switch 809 mutes the output channel 414.

Similar functionality is provided for stereo output channel 415, which supplies the second pair of headphones 110, and channel 416, which supplies the auxiliary outputs of the audio interface 101. Switches and faders 810 to 819 operate as described with respect to channel 414. A master output slider 820 sets the level heard on the loudspeakers 115 and 116.

It will be appreciated that the virtual mixer 400 shown in FIG. 4 and whose elements have been described with reference to FIGS. 5, 6 7 and 8, enables a user-defined distribution of signals to be established. The distribution of audio signals from analog inputs to analog outputs on the audio interface 101 is performed by the audio interface 101, in order to minimize audio latency and to provide a professional quality recording environment without the cost and complexity that would otherwise be required.

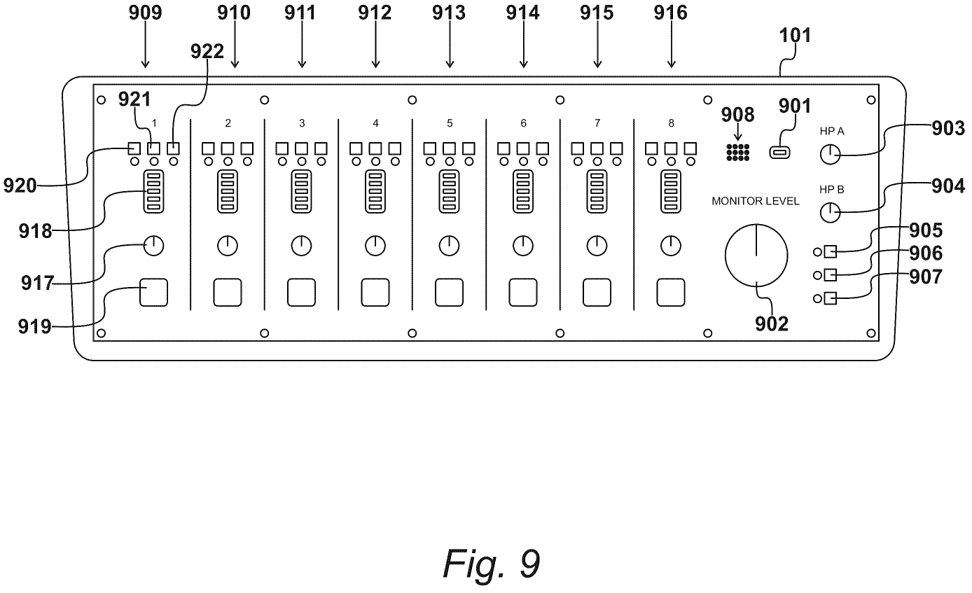

### FIG. 9

The audio interface 101 shown in FIG. 1 is detailed in FIG. 9. A power indicator light-emitting diode (LED) 901 indicates when the interface 101 is switched on and is receiving power from the laptop 102 via the USB connection 103. A monitor level control 902 facilitates convenient adjustment of levels of signals supplied to the loudspeakers 115 and 116. Similarly, controls 903 and 904 set the levels supplied to headphones 108 and 110 respectively. A cut switch 905 enables the main output left and right signals to be silenced while a dim switch 906 can be used to reduce their levels. A talkback switch 907 activates a talkback microphone 908, giving the same effect as the switch 614 shown in FIG. 6 and causing the appearance of the virtual switch 614 to be updated accordingly.

The audio interface 101 has controls for eight analog input channels 909 to 916, corresponding to virtual mixer input channels 401 to 408 respectively shown in FIG. 4. The first analog input channel 909 includes an analog input level control 917, a level meter 918 and an analog harmonic enhancement switch 919. Switches 920, 921 and 922 have the same functionality as virtual switches 502, 503 and 504 respectively, shown in FIG. 5. These controls 917 to 922 are repeated for each of the remaining seven analog input channels 910 to 916.

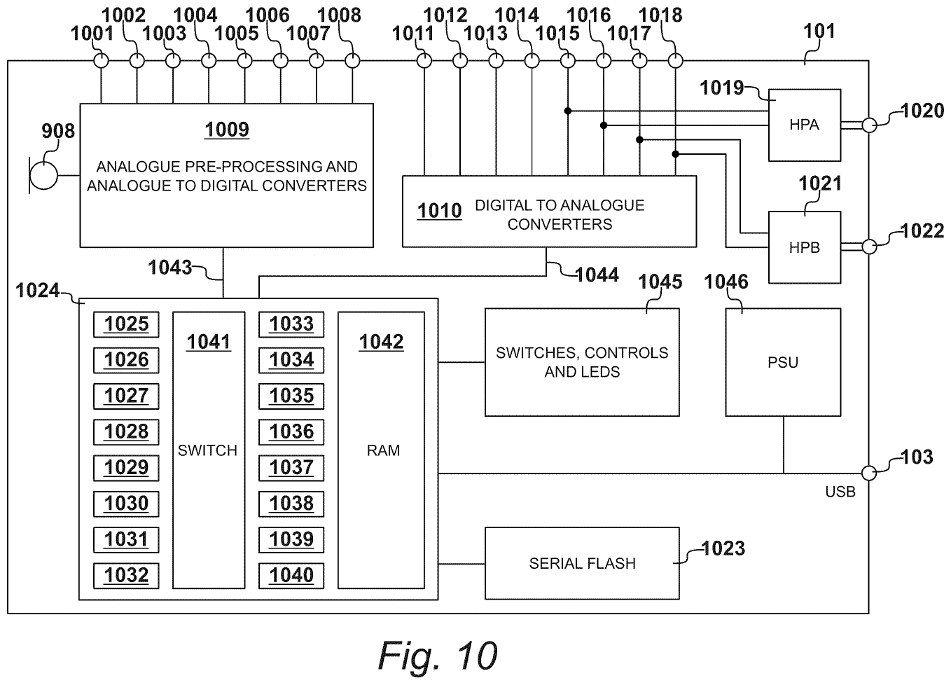

### FIG. 10

Internal hardware components of the audio interface 101 shown in FIG. 9 are detailed in FIG. 10. Eight analog audio input connectors 1001 to 1008 for channels 909 to 916 are internally connected to analog pre-processing circuits and analog-to-digital converters (ADCs) 1009. The microphone 105 is connected to input connector 1001. Keyboards 106 and 107 are connected to inputs 1003 to 1006. In addition, the talkback microphone 908 has its own ADC included in the analog input circuitry 1009. Digital-to-analog converters (DACs) 1010 are provided, along with associated analog output circuitry for eight analog audio outputs 1011 to 1018. Analog outputs 1015 and 1016 supply a headphone amplifier 1019 which has a stereo output jack socket 1020, providing a wired connection to the first pair of headphones 108. Similarly, analog outputs 1017 and 1018 supply a headphone amplifier 1021 which has a stereo output jack socket 1022 that provides a wired connection to the second pair of headphones 110.

A non-volatile serial flash memory 1023 stores firmware instructions installed at step 207 in FIG. 2. A Central Processing Unit (CPU) 1024 executes these firmware instructions and distributes signals from the inputs 1001 to 1008 to the outputs 1011 to 1018. The CPU 1024 may be an XU216-512-TQ128 made by XMOS Limited, 5th Floor East, Programme, 1 All Saints Street, Bristol BS1 2LZ, United Kingdom. Documentation and supplier information for the CPU 1024 are also available online at www.xmos.ai. The CPU 1024 includes sixteen parallel processing cores 1025 to 1040 that communicate using a crosspoint switch 1041. Five hundred and twelve kilobytes of Static read-and-write Memory (RAM) 1042 is provided for allocation to the processing cores 1025 to 1040. RAM 1042 stores data and instructions and is loaded with firmware from the serial flash 1023 when power is initially provided to the audio interface 101. The cores 1025 to 1040 then execute instructions allocated for their respective functions until the audio interface 101 is switched off.

The audio interface 101 also includes interface circuitry 1045 including switches, controls and LEDs, such as the monitor level control 902, switches 905, 906, 907 and other items visible on the front panel of the audio interface 101. Power supply (PSU) circuitry 1046 includes limiters for preventing high voltages from reaching the CPU 1024 and other circuits of the audio interface 101. The CPU 1024 includes USB interface hardware for the USB connection 103 shown in FIG. 1. The CPU 1024 connects with other parts of the audio interface using a variety of types of connection. Digital audio samples from the ADCs 1009 are supplied to the CPU 1024 via high-speed serial digital interfaces 1043. Additional high speed serial digital interfaces 1044 facilitate transfer of distributed audio samples to the DACs 1010. The USB connection 103 also facilitates high speed bidirectional transfer of digital audio samples between the audio interface 101 and the DAW 208 running on the laptop 102.

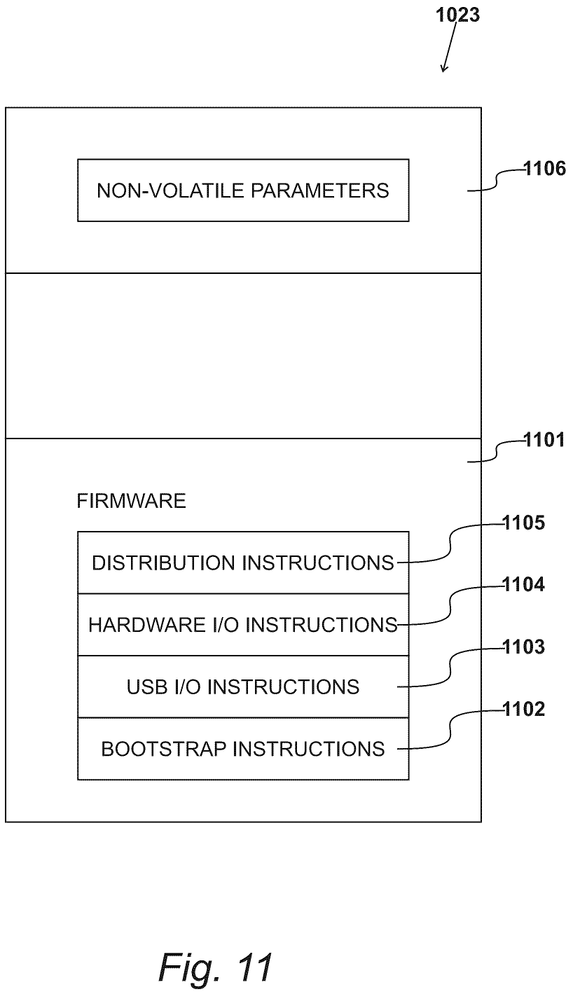

### FIG. 11

Contents of the serial flash memory 1023 shown in FIG. 10 are detailed in FIG. 11. Firmware 1101, installed at step 207 in FIG. 2, includes bootstrap instructions 1102, USB Input and Output (I/O) instructions 1103, hardware I/O instructions 1104 and distribution instructions 1105. Non-volatile user-defined parameters 1106 are also installed on the serial flash 1023. Non-volatile parameters ensure that the state of switches 905, 907, 907, 920, 921, and 922 are restored as soon as power is applied to the audio interface 101. If, for example, phantom power is required for the microphone 105, non-volatile parameters 1106 will automatically re-establish phantom power for the first channel input 1001 when the audio interface 101 is switched on. Bootstrap instructions 1102 enable the CPU 1024 to configure allocation of RAM 1042 to each of the processing cores 1025 to 1040 as required, and then to transfer instructions to each core's allocated RAM and then start their execution.

The USB instructions 1103 implement a standard multichannel audio service for bidirectional multichannel audio streaming over the USB connection 103. The USB instructions 1103 additionally implement a custom service for bidirectional transfer of data relating to how audio signals are to be distributed. Hardware I/O instructions 1104 facilitate communication with all the hardware in the audio interface 101, including analog pre-processing and ADCs 1009, DACs 1010, switches, controls and LEDs 1045.

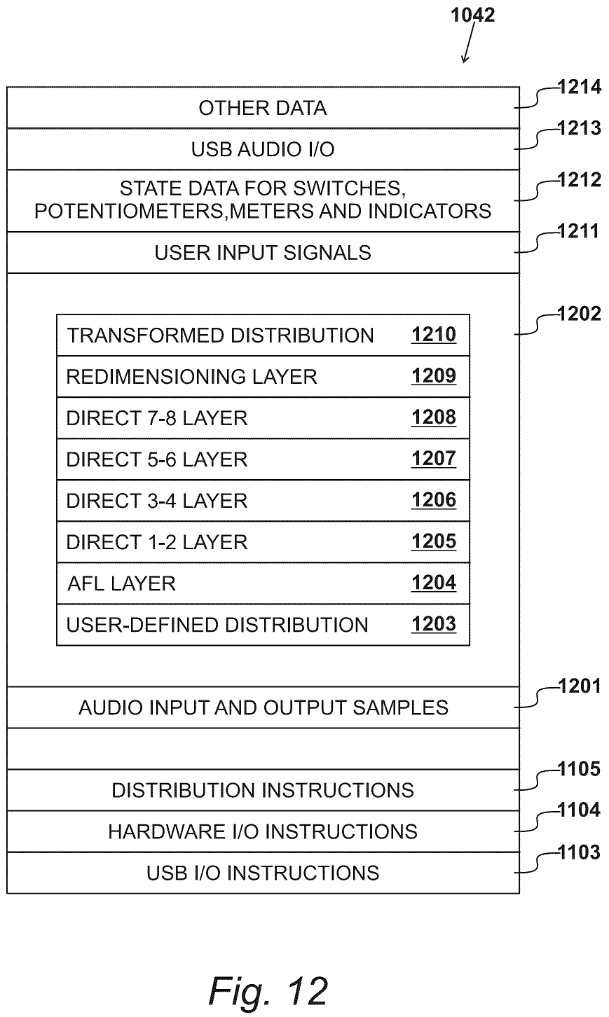

### FIG. 12

Contents of RAM 1042 shown in FIG. 10 are detailed in FIG. 12. Instructions for the processor cores 1025 to 1040 are copied from the non-volatile serial flash 1023 to respective allocated portions of RAM during a bootstrap process. Compartmentalization of RAM allocated to respective cores 1025 to 1040 is not shown in FIG. 12, as this will readily be understood and implemented by those skilled in the art, and for clarity, RAM contents are shown here in a simplified, unified way. USB I/O instructions 1103, hardware I/O instructions 1104 and distribution instructions 1105 are copied into RAM 1042 from where they are executed by processing cores 1025 to 1040. The remainder of RAM 1042 contains data.

Audio input and output samples 1201 include input samples obtained from ADCs 1009 and output samples that will be supplied to DACs 1010. Layers 1202 include a user-defined distribution 1203, an after-fade listen (AFL) masking layer 1204, a direct 1-2 masking layer 1205, a direct 3-4 masking layer 1206, a direct 5-6 masking layer 1207, a direct 7-8 masking layer 1208, a re-dimensioning layer 1209 and a transformed distribution 1210. In an alternative embodiment, the direct masking layers 1205 to 1208 are implemented in a single direct masking layer. The layers 1202 operate with distribution instructions 1105 to facilitate layer-specific functionality. Each transforming layer 1205 to 1209 provides an instance of a layer that can modify and transform in some way, the underlying user-defined distribution 1203.

RAM 1042 further includes user input signals 1211 from physical controls 1045 on the audio interface 101 and virtual controls on the virtual mixer 400 received from the laptop 102 via the USB connection 103. State data 1212 includes data representing the state of real and virtual switches, potentiometers, controls meters and indicators. Virtual potentiometers include rotary controls such as pan 506 and gain 507, as well as virtual sliders such as the level slider 518. USB audio I/O 1213 stores buffered audio data received from and due to be sent to the DAW 1208 running on the laptop 102. Other data 1214 includes a stack for each of the cores 1025 to 1040 and other variables and state data used when executing instructions 1103, 1104 and 1105 on the cores 1025 to 1040.

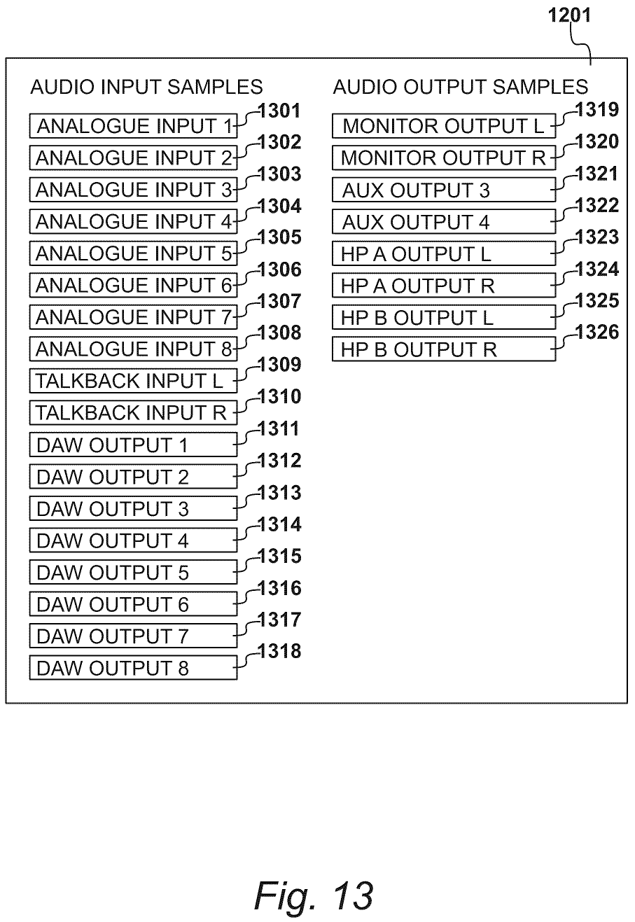

### FIG. 13

The virtual mixer shown in FIG. 4 facilitates definition of a distribution of audio signals from analog inputs 1001 to 1008 to analog outputs 1011 to 1018. Furthermore, distribution may include outputs from the DAW 208 running on the laptop 102 which will be used as additional distributable audio inputs. The full set of input audio input samples and output audio samples 1201 shown in FIG. 12 is detailed in FIG. 13.

Eight analog input samples 1301 to 1308 are obtained by analog-to-digital conversion 1009 of analog signals supplied to inputs 1001 to 1008 respectively. A left talkback sample 1309 and a right talkback sample 1310 are obtained by conversion of analog signals from the talkback microphone 908. Eight input samples 1311 to 1318 from the DAW 208 are also available for distribution. These are distributed when playing back previously recorded tracks. The audio input samples 1301 to 1318 are distributed to eight audio output samples 1319 to 1326. These output samples are monitor outputs, left and right 1319, 1320 respectively, auxiliary (aux) output left and right 1321, 1322 respectively, headphone A output left and right 1323, 1324 respectively and headphone B output left and right 1325, 1326 respectively.

In the following description, input samples 1301 to 1318 are also referred to as input channels when describing processing actions performed on them. Similarly, output samples 1319 to 1326 are referred to as output channels when describing processing actions relating to their calculation.

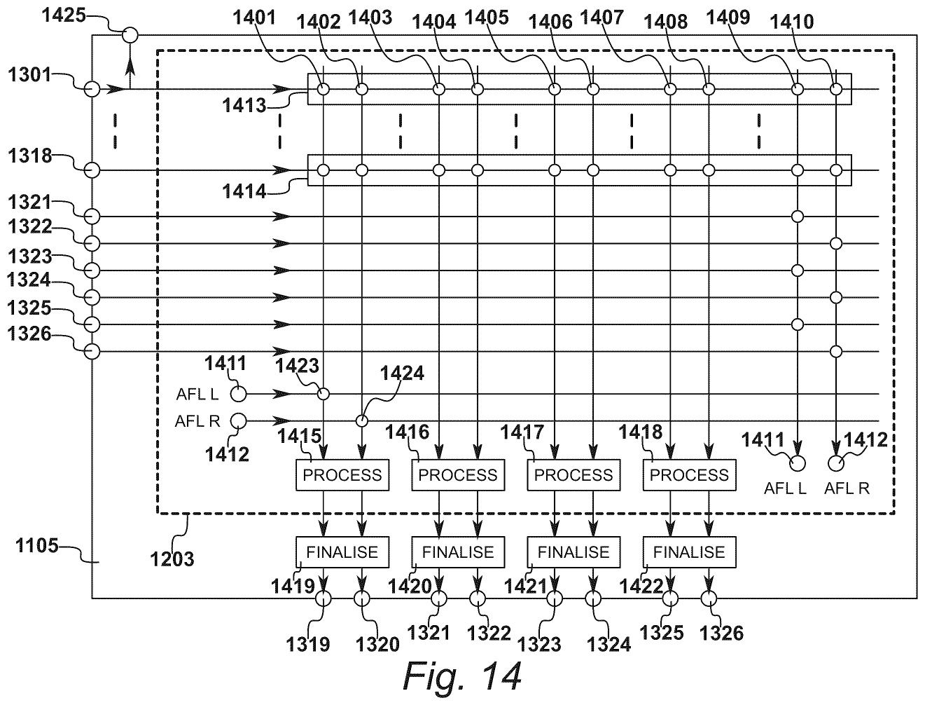

### FIG. 14

Signal flow in the audio interface resulting from execution of the distribution instructions 1105 is summarized in the signal flow diagram shown in FIG. 14. Audio input sample 1301 supplies audio distribution node 1401 which distributes a portion of the input 1301 to output 1319. Similarly, nodes 1402 to 1408 distribute portions of the input 1301 to outputs 1320 to 1326. Nodes 1409 and 1410 distribute the input 1301 to a left AFL bus 1411 and a right AFL bus 1412 respectively. The nodes 1401 to 1410 distribute the input 1301 in accordance with an input distribution 1413 which implements functionality such as gain and pan of the input 1301 to each of the outputs 1319 to 1326 and the AFL bus 1411, 1412. The input distribution 1413 is mostly established by the user 109 using the first channel 401 of the virtual mixer 400.

Input samples 1302 to 1318 are similarly distributed, each with their own respective nodes defining their respective input distribution, such as input distribution 1414 shown for input sample 1318.

Output sample 1319 is a modified sum of respective distributed inputs. A post-processing stage 1415 defines left-to-right balance and overall output gain for the left and right outputs 1319 and 1320. It will be appreciated that the functionality of the post-processing stage 1415 can be conflated with gains of nodes including node 1401 in order to obtain an equivalent effect. Therefore, the user-defined distribution 1203 includes the effect of post-processing stages 1415, 1416, 1417 and 1418, as well as gains defined in accordance with input distributions 1413 and 1414.

Additional processing is performed for the left and right monitor output samples 1319 and 1320 by a finalizer 1419. Finalizing 1419 includes metering and setting the output level in response to the monitor level control 902 on the audio interface 101. Additional finalizers 1420, 1421 and 1422 perform metering for their respective outputs 1321 to 1326.

Outputs 1321 to 1326 are also supplied as inputs for distribution to the AFL bus 1411, 1412. This implements AFL switching 808, 813 and 817 shown in FIG. 8. In the user-defined distribution 1203, the AFL bus outputs 1411 and 1412 are distributed to the left and right monitor samples 1319 and 1320 by nodes 1423 and 1424 respectively.

FIG. 14 illustrates the user-defined distribution 1203, omitting repeated elements for input samples 1302 to 1317. Input sample 1301 is additionally supplied as an output 1425 over the USB connection 103 via the USB audio I/O 1213 so it can be recorded on the laptop 102 by the DAW application. Similar USB outputs are provided for the other input samples 1302 to 1308.

The user-defined distribution 1203 will be understood as defining a pattern of signal distribution between audio inputs and audio outputs. This user-defined distribution 1203 may be further modified or partially overridden by user input signals 1211 generated by the user 109 in order to provide additional functionality during the process of recording musical performances.

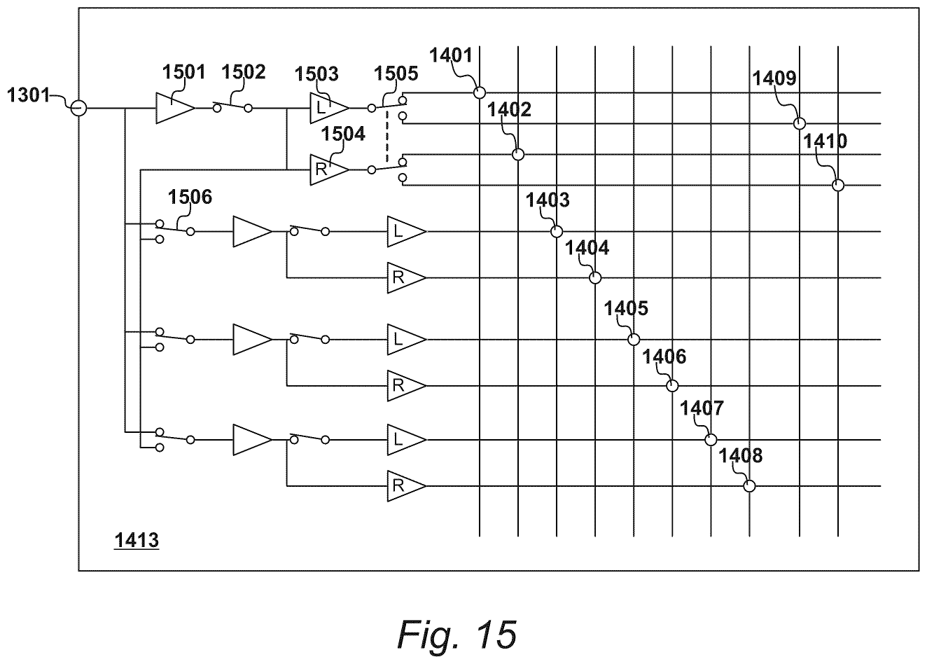

### FIG. 15

The input distribution 1413 shown in FIG. 14 is detailed in FIG. 15. The audio sample 1301 from the first analog input channel 909 supplies a first multiplier 1501 that implements slider 518. This is followed by a switch 1502 that implements the virtual cut switch 520. Left and right balance multipliers 1503 and 1504 implement the virtual pan 517. A switch 1505 implements the virtual solo switch 519, which directs the channel's signal to the AFL bus 1411, 1412. Another switch 1506 implements the virtual post switch 817. In this conceptual representation of the input distribution 1413 the gains of nodes 1401 to 1410 are set to unity.

In practice, it will be appreciated that much of the signal processing 1413 shown in FIG. 15 is conflated such that input switches and controls are implemented by appropriate setting of nodes 1401 to 1410 to non-unity values, and that additional input processing, such as 1501 to 1506 is not actually performed when distributing input 1301 to the audio outputs 1319 to 1326. The same is true of the other input channels 1302 to 1318. In particular, switch 1505 is implemented by a combination of setting the gain 1401 and 1402 and by propagating these gains 1401, 1402 through the AFL masking layer 1204.

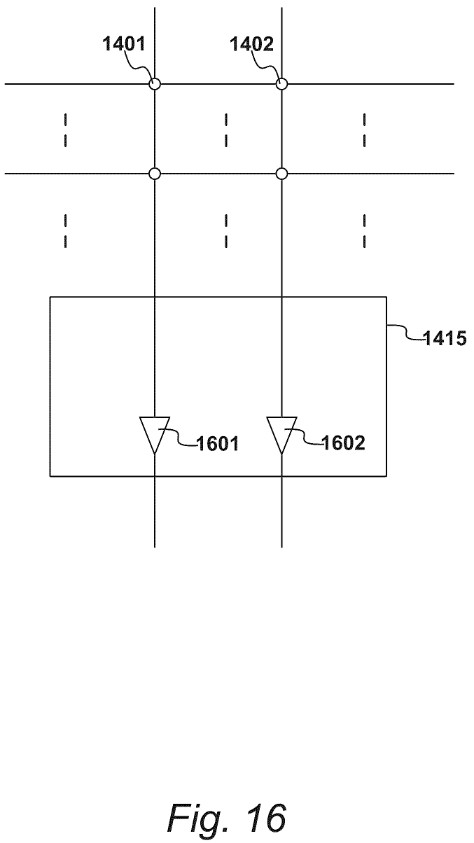

### FIG. 16

Post-processing 1415 shown in FIG. 14 is detailed in FIG. 16. Multipliers 1601 and 1602 implement the virtual slider 820 shown in FIG. 8.

In practice, multipliers 1601, 1602 are implemented by appropriate modification of nodes 1401, 1402 that distribute portions of input sample 1301 to the outputs 1319 and 1320, along with similar appropriate modifications to the other nodes affecting the respective output samples.

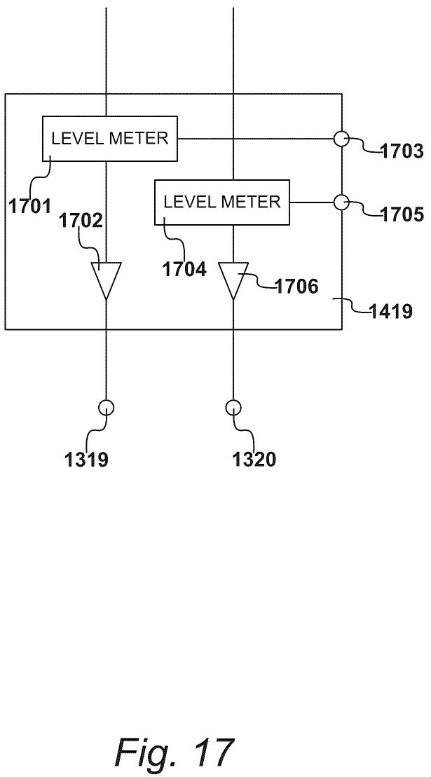

### FIG. 17

The finalizer 1419 shown in FIG. 14 is detailed in FIG. 17. A left channel level meter 1701 receives an output signal and passes it through to a multiplier 1702 that sets the magnitude of the left monitor output sample 1319 in accordance with the position of the monitor level control 902 on the front panel of the audio interface 101. The level meter 1701 calculates an indicative level and supplies this as an output 1703 that is transmitted to the laptop 102 over the USB connection 103. A second level meter 1704 calculates an indicative level and supplies this as an output 1705 to the laptop 102. The second level meter passes its input through to a multiplier 1706 that sets the magnitude of the right monitor output sample 1320 in accordance with the position of the monitor level control 902. Cut 905 and dim 906 switches are implemented by suitable setting of the gains of multipliers 1702 and 1706. The Master output level meter 804 shown in FIG. 8 is updated in accordance with the left and right meter outputs 1703 and 1705.

The finalizers 1420, 1421 and 1422 also shown in FIG. 14 operate similarly and use the multipliers 1702 and 1706 to implement virtual cut switches 809, 814, and 818. Meter signals for meters 801, 802 and 803 are generated by finalizers 1420, 1421 and 1422 respectively.

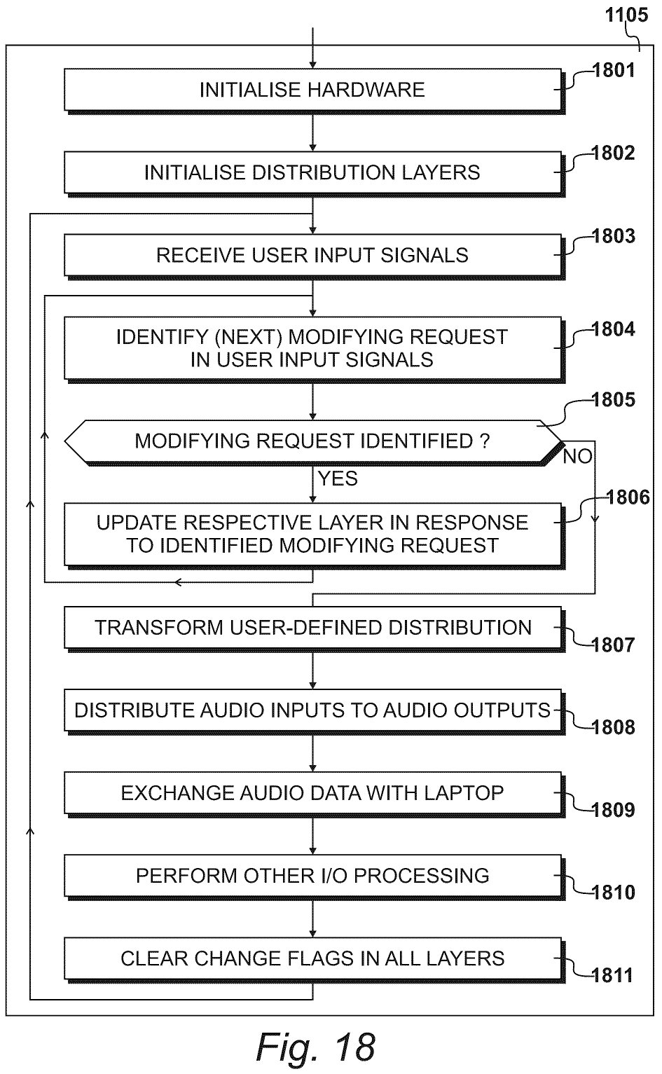

### FIG. 18

Processing steps performed by the distribution instructions 1105 shown in FIG. 11 are detailed in FIG. 18. At step 1801 hardware components of the audio interface 101 are initialized along with data structures used in association with the hardware components. This includes all the hardware shown in FIG. 10. At step 1802 the layers 1202 are initialized. This includes clearing all flags contained in the layers. At step 1803 user input signals 1211 are received. User input signals 1211 are received from the laptop 102 and from the switches and controls of the audio interface 101.

At step 1804 an attempt is made to identify a modifying request in the user input signals 1211. A modifying request is a request contained in the user input signals 1211 for modifying or partially overriding the user-defined distribution 1203. If successful, step 1805 directs control to step 1806 where the user-defined distribution 1203 or one of the transforming layers 1204 to 1208 is updated in response to the identified modifying request. Steps 1804 to 1806 are repeated until there are no further modifying requests that can be identified in the user input signals 1211. A first example of a modifying request is when virtual fader 518 is adjusted. This causes nodes 1401 and 1402 to be updated in the user-defined distribution 1203. Another example of a modifying request is when the virtual solo switch 519 is activated. This causes the AFL layer 1204 to be activated, causing it to become a modifying layer. A third example is when the direct switch 702 is activated, causing direct 1-2 layer 1205 to be activated, making it a modifying layer. The AFL layer 1204 is a specialized instance of a masking gain layer. Direct layers 1205 to 1208 are also specialized instances of a masking gain layer.

When layer 1204 is activated, changes in its state are passed to the next layer up, so it will be possible to skip calculations for parts of the transformed distribution 1210 that will not change as a result of user input.

Eventually, no further modifying requests can be identified, and control is directed to step 1807 where the user-defined distribution 1203 is transformed. At step 1808 signals from audio inputs 1001 to 1008 are distributed to audio outputs 1011 to 1018. Additional audio inputs 1311 to 1318 received from the laptop are also distributed to the audio outputs 1011 to 1018 at step 1808.

At step 1809 audio data is exchanged with the laptop 102. This exchange is subject to audio latency. However, because any live monitor or headphone mixes are created locally within the hardware of the audio interface 101, latency for the microphone 105 and keyboards 106, 107 is minimized in the signals supplied to the headphones 108, 110. Input samples 1301 to 1308 are supplied to the laptop 102 so they can be recorded for subsequent playback and mixing at step 1809. Output samples 1311 to 1318 are received from the laptop 102 at step 1809.

At step 1810 other input and output processing is performed, including supplying meter levels to the laptop 102 for display on the virtual mixer 400. At step 1811 all change flags contained within the layers 1203 to 1210 are cleared. The purpose of this action will become clear when describing propagation of changes through the layers 1203 to 1210. After step 1811 is complete, steps 1802 to 1811 of FIG. 18 are repeated until the audio interface 101 is switched off. It will be appreciated that the steps may be performed at different rates. For example, steps 1803 to 1807 may be performed at an integer fraction of the audio sampling rate, while distribution of audio inputs to audio outputs, performed at step 1808, must be done at the audio sampling rate, which may be selected as being 44.1 KHz, 48 KHz or 96 KHz by the user 109 using an additional interface menu in the virtual mixer 400. However, for clarity, such details have been omitted, as these will be readily understood by those skilled in the art.

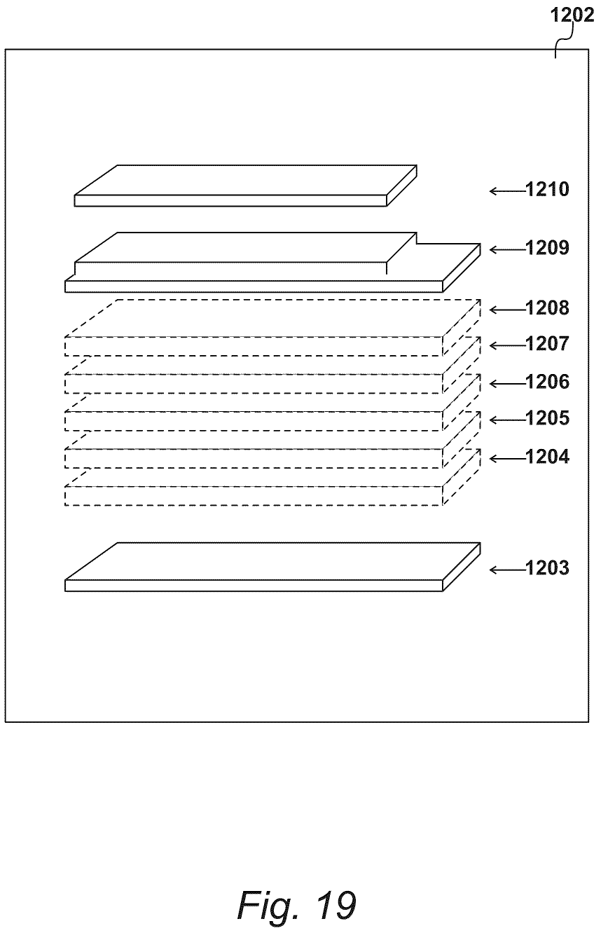

### FIG. 19

The layers 1202 shown in FIG. 12 are detailed in FIG. 19. The user-defined distribution 1203 is the base layer. AFL layer 1204 and direct layers 1205 to 1208 are shown as deactivated, indicated by dotted outlines. These transforming layers 1204 to 1208 have the same dimensions for their inputs and outputs. The re-dimensioning layer 1209 has larger dimensions for its inputs than for its outputs. In effect, it performs a reduction in size of a matrix of distribution gains.

Distribution gains, such as the gain of node 1401 in the user-defined distribution 1203, propagate upwards through the layers 1204 to 1209. This upward propagation transforms the user-defined distribution 1203. Furthermore, the resulting transformed distribution 1210 has a smaller number of distribution gains than the user-defined distribution 1203, due to propagation of these gains through the re-dimensioning layer 1209.

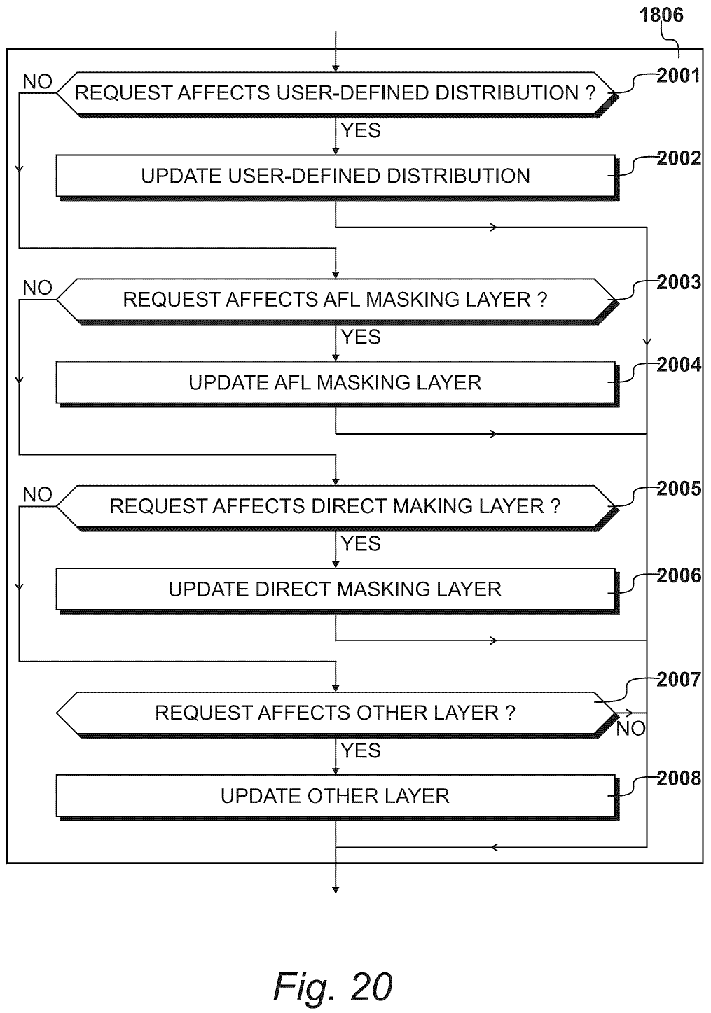

### FIG. 20

The step 1806 of updating a layer, shown in FIG. 18, is detailed in FIG. 20. At step 2001 a question is asked as to whether the modifying request, identified at step 1804 in FIG. 18, affects the user-defined distribution 1203. If so, the user-defined distribution 1203 is updated at step 2002. If not, control is directed to step 2003, which determines whether the request affects the AFL masking layer 1204. If so, the AFL masking layer 1204 is updated at step 1205.

Alternatively, control is directed to step 2005 where a question is asked as to whether the modifying request affects one of the direct masking layers 1205 to 1208. If so, the respective direct masking layer is updated at step 2006. If not, control is directed to step 2007, which determines whether the request affects another type of layer. If so, the other type of layer is updated at step 2008. Other types of layers are implemented in alternative embodiments that will be described with reference to later figures.

The steps of FIG. 20 will be understood as selecting functionality for a specific type of layer, thereby implementing polymorphism which can be defined using the constructs of a high-level object-oriented programming language, such as C++.

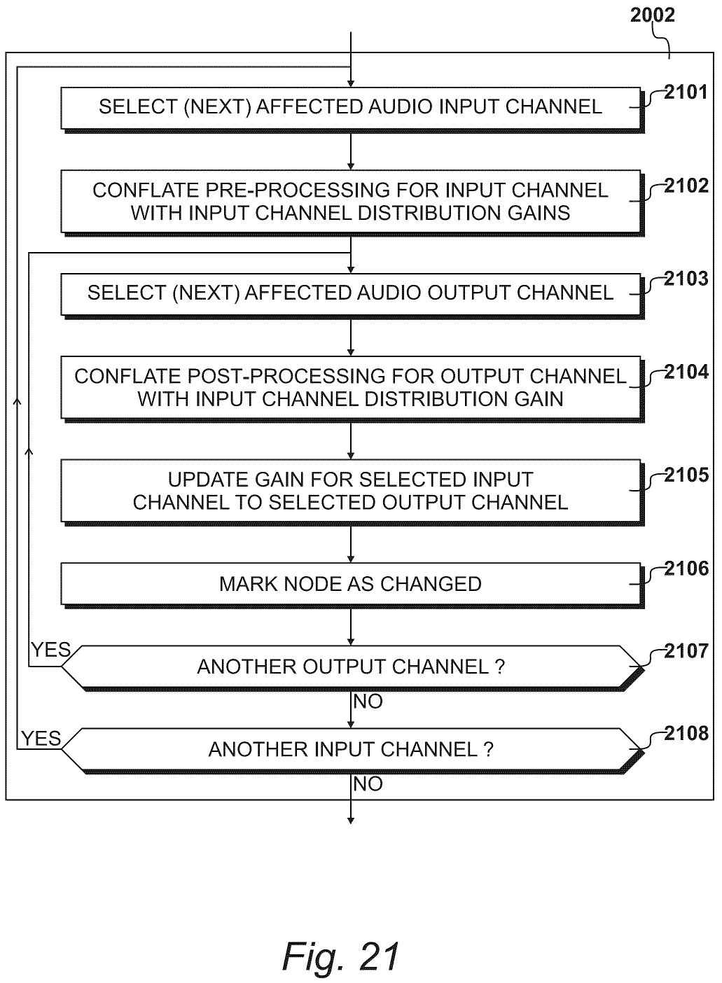

### FIG. 21

The step 2002 of updating the user-defined distribution 1203 shown in FIG. 20, is detailed in FIG. 21. At step 2101 the first audio input channel affected by the request is selected. For example, audio input channel 1301 may be selected, and will be used by way of example in the following steps. At step 2102 input channel pre-processing 1413 is conflated with input channel distribution gains 1401 to 1410 so that the input channel distribution gains 1401 to 1410 implement the pre-processing functionality 1413 detailed in FIG. 15. Solo functionality indicated by the switch 1505 in FIG. 15, and which implements the solo switch 519 in the virtual input channel 401 shown in FIG. 5 is taken into account by setting the appropriate levels for gains 1401, 1402 and 1409, 1410. If the solo switch is activated, gains 1401 and 1402 will be set to zero and gains 1409 and 1410 will be set to an appropriate value based on the settings of the fader 518 and pan control 517 and so on. However, the exclusive routing implied by setting a solo switch 519 is not handled by the user-defined distribution 1203. Instead, solo and AFL routing will be implemented by the AFL masking layer 1204 when the user-defined distribution 1203 is transformed 1807.

In a special case of step 2102, the input channel is a bus output 1321 to 1326 which is processed as an input in a simplified way in order to enable it to contribute to an AFL bus 1411 or 1412 when an AFL switch 808, 813 or 817 is activated.

At step 2103 the first audio output channel affected by the modifying request is selected. For example, audio output channel 1319 may be selected, and will be used by way of example. At step 2104 output channel post-processing 1415 is conflated with the respective input channel distribution gain 1401 so that the gain 1401 implements the post-processing functionality 1415 detailed in FIG. 16. At step 2105, the gain for the selected input channel 1301 to the selected output channel 1319 is written to the respective node 1401 or possibly 1409 in the user-defined distribution 1203.

At step 2106 the updated gain is marked as changed by setting a flag within the data structure of the layer 1203. This setting of a changed flag triggers the setting of the changed flags for all dependent nodes in layers above the lowest layer 1203.

At step 2107 control is directed back to step 2003 so that any remaining affected output channels 1319 to 1326 are processed by steps 2104 to 2106. At step 2108 control is directed back to step 2001 so that any remaining affected input channels 1301 to 1318 are processed by steps 2102 to 2107. In addition, output channels 1321 to 1326 may also be processed as inputs in order to allow these to contribute to the AFL bus 1411, 1412 when their respective AFL switches 808, 813 or 817 are activated.

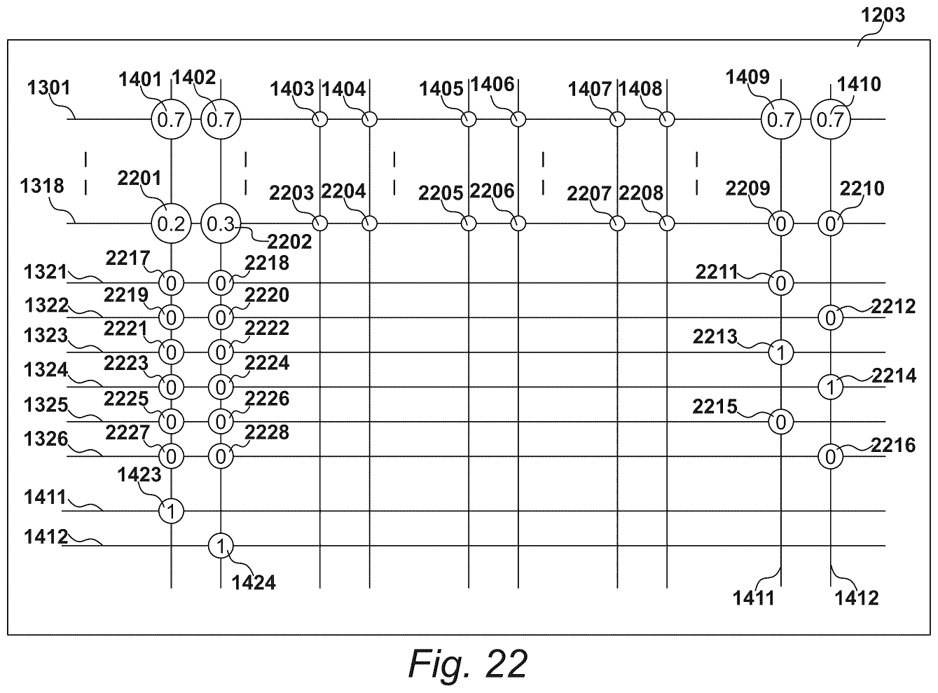

### FIG. 22

The effect of step 2002 of updating the user-defined distribution 1203 is illustrated in FIG. 22. Nodes 1401 and 1402 of the first input channel 1301 are set to values of 0.7 as a result of movement of virtual fader 518. These changed values are indicated in FIG. 22 by the larger diameter of the nodes. This channel's solo switch 519 is set, so AFL gain nodes 1409 and 1410 are given the same values as nodes 1401 and 1402, respectively. Playback input channel 1318 has had its virtual fader 716 moved, resulting in changed values for nodes 2201 and 2202. Other nodes 2203 to 2210 for this playback channel remain unchanged, as indicated by nodes shown with a smaller diameter. This playback channel's solo switch is not set, so its AFL gain nodes 2209 and 2210 both have a value of zero. Other AFL gain nodes 2211 to 2216 define playback AFL levels, and it can be seen that playback stereo pair 1323 and 1324 have been set to a value of 1.0, as a result of AFL switch 813 being set.

Additionally, the user-defined distribution 1203 includes two fixed-value nodes 1423 and 1424, both set to a value of 1.0. The purpose of this will become apparent subsequently. Other nodes in the user-defined distribution 1203 can be assumed to take the value zero by default. Such zero distribution factors can be ignored when distributing signals. However, for the purposes of the embodiment, nodes 2217 to 2228 are shown with explicit zero values, as these will be required for processing associated with the re-dimensioning layer 1209.

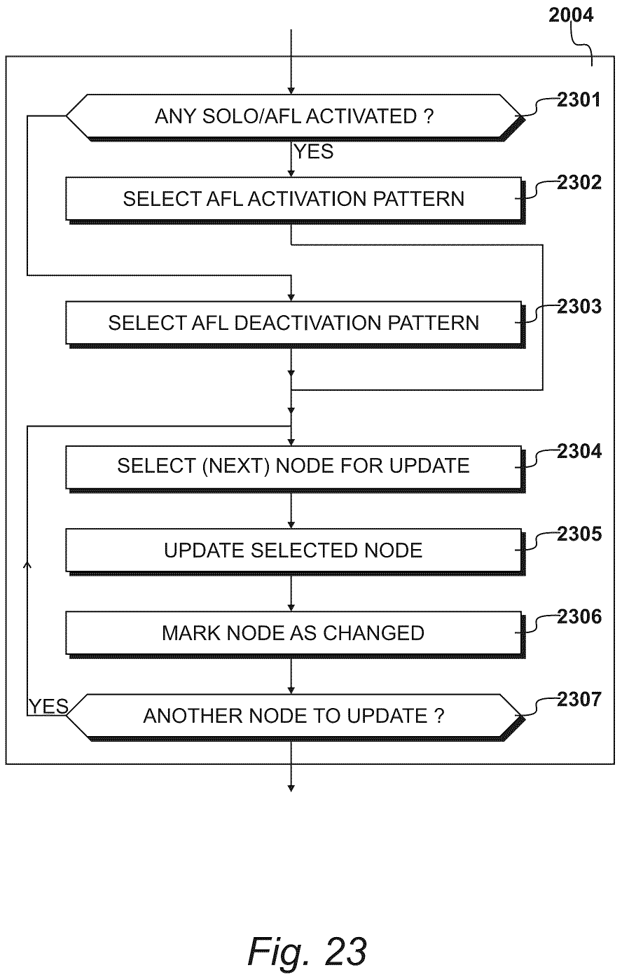

### FIG. 23

The step 2004 of updating the AFL masking layer 1204 shown in FIG. 20, is detailed in FIG. 23. At step 2301 a question is asked as to whether any solo or AFL switch is activated. If so, control is directed to step 2302 where an AFL activation pattern is selected. If not, an AFL deactivation pattern is selected at step 2303. At step 2304 the first node in the AFL masking layer 1204 is selected for update. At step 2305 the selected node is updated with the appropriate value from the pattern selected at step 2302 or step 2303. At step 2306 the updated node is marked as changed, by setting a flag within the data structure of the layer 1204. This setting of a changed flag triggers setting of the changed flags for all dependent nodes in layers above the AFL layer 1204. At step 2306 a question is asked as to whether there are any remaining nodes to update. If so, control is directed back to step 2304 so that all nodes in the layer 1204 are updated with the pattern selected at step 2302 or step 2303.

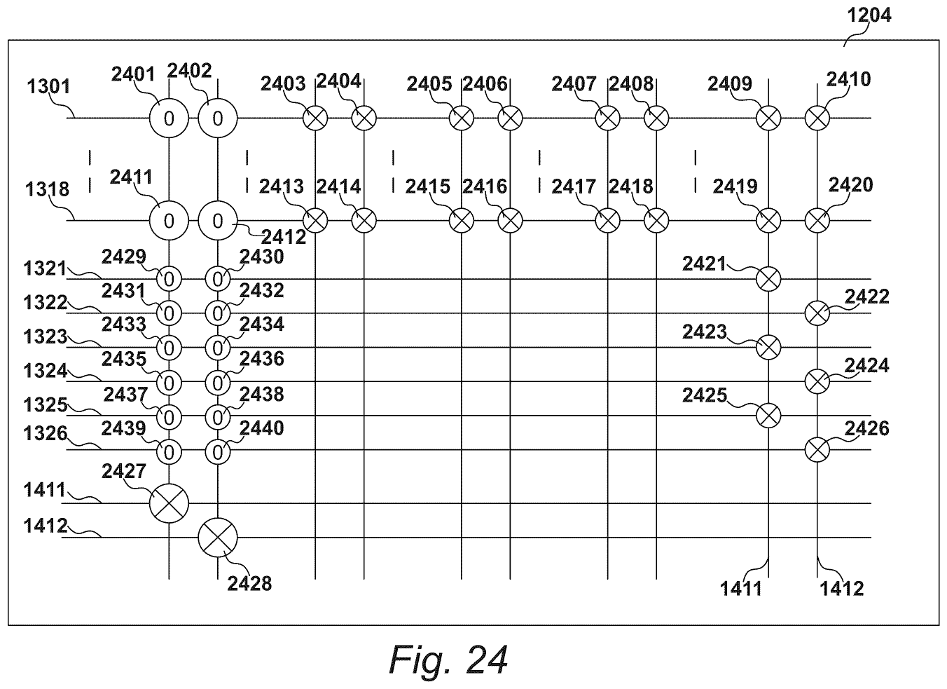

### FIG. 24

The masking layer 1204 shown in FIG. 12 is detailed in FIG. 24. The layer comprises a two-dimensional matrix of function nodes 2401 to 2428. The function nodes not only store values; they are capable of performing a desired function specific to each node as required to implement the functionality of the layer 1204. For example, a function node may mask the gain of a corresponding node in a lower layer 1203. A function node is also responsible for propagating a change condition from the layer 1203 below to the layer 1205 above. In some cases, a node may be a pass-through node that copies the output from a node in the layer below to a node in the layer above. Nodes in other layers may perform other kinds of functions. For example, a node in a volume-applying layer may multiply a gain from a node in a lower layer by a factor to adjust the overall gain. It will be appreciated that each layer 1204 to 1209 may be understood as a function matrix comprising a two-dimensional array of function nodes, such as nodes 2401 to 2428 in layer 1204. Each function matrix is a layer in a respective third dimension in a transforming stack 1203 to 1210 of function matrices that is used to determine the distribution of audio signals.

The activation pattern selected at step 2302 in FIG. 23 is detailed in FIG. 24. This pattern is selected when any of the solo 519, 717 or AFL switches 808, 813, 817 are activated. Nodes 2401 and 2402 are updated with values of zero. Nodes 2403 to 2410 are pass-through nodes, as indicated by a cross in the node symbol. In practice, a pass-through node is implemented by a null value, as opposed to a numerical value. The effect of a pass-through node is to pass the value from a lower layer, which in this case is the user-defined distribution 1203, through the layer without any modification. In addition to passing the value through in this way, similarly, the setting of dependent change flags is passed through, so that the presence of a changed gain in the user-defined distribution 1203 can be detected by higher layers when necessary.

All input channels are set with the same pattern. Nodes 2411 to 2420 are set with the same pattern as nodes 2401 to 2410. In this case, AFL is activated. Taking the first input channel 1301 as an example, the main output gains 1401 and 1402 are masked by the zero-valued nodes in the AFL layer 2401, 2402. The AFL amounts for input 1301 are defined by nodes 1409 and 1410. Example values shown in FIG. 22 are 0.7 for both these nodes. In the AFL layer 1204 the null-valued pass-through nodes 2409 and 2410 pass the values 0.7 upwards through the layer. By contrast, the values of nodes 2201 and 2202 shown in FIG. 22 are set to example values of 0.2 and 0.3 respectively. Because the AFL layer 1204 is activated, nodes 2411 and 2412 will mask these values, replacing them with gain factors of zero. Given that AFL is inactive for input 1318 in this example, nodes 2209 and 2210 are set to zero, so that the value passed through by nodes 2419 and 2420 will also be zero, and input 1318 will not be distributed to the AFL bus.

It will be appreciated that most of the pass-through nodes shown in FIG. 24 never change and are also pass-through nodes even when the AFL layer 1204 is deactivated, as will be seen. However, there are two exceptions. Nodes 2427 and 2428 are set to pass-through when AFL is activated, but are set to zero when AFL is deactivated, as will be seen in the next figure. The values propagated by nodes 2427 and 2428 are both 1.0. These cause the summed contents of the AFL bus 1411 and 1412 to be distributed to the main outputs 1319 and 1320.

Nodes 2429 to 2440 are set to zero when AFL is activated. In other embodiments, nodes 2217 to 2228 shown in FIG. 22, may be set to non-zero values, thereby requiring nodes 2429 to 2440 to be set to zero, in order to implement the required AFL functionality.

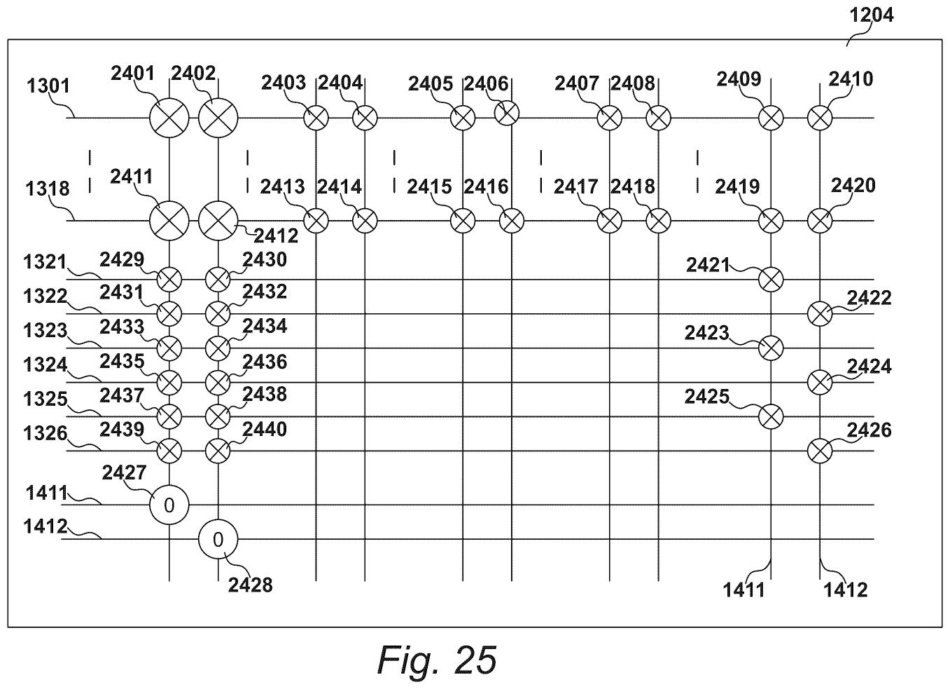

### FIG. 25

The deactivation pattern selected at step 2303 in FIG. 23 is detailed in FIG. 25. This pattern is selected when all the solo 519, 717 and AFL switches 808, 813, 817 are deactivated. Nodes 2401 and 2402 are updated with null values, defining them as pass-through nodes. Taking again the example values shown in FIG. 22, nodes 1401 and 1402 will now be passed through the AFL layer, and input 1301 will be distributed to the main outputs 1319 and 1320.

Nodes 2427 and 2428 may be set to zero when AFL is deactivated, although in practice this is superfluous, given that none of the AFL contributing nodes 1409, 1410, 2209 to 2216 are set to a non-zero value when all the solo and AFL switches are deactivated. From a purely functional perspective, and in another embodiment, nodes 2427 and 2428 may be set to pass-through values at all times. Nodes 2429 to 2440 are set to pass-through values when AFL is deactivated, to ensure compatibility with embodiments in which nodes 2217 to 2228 can take non-zero values.

Comparison between FIG. 24 and FIG. 25 shows how the AFL masking layer 1204 is activated or deactivated in response to user input signals 1211. The AFL layer 1204 simplifies AFL routing that would otherwise be costly to implement.

Note that crosspoints without marked nodes, such as the crosspoint of input 1321 and the vertical bus leading to output 1322, are assumed to have a gain factor of zero and can be excluded from the multiply accumulation process when distributing audio inputs to audio outputs performed at step 1808.

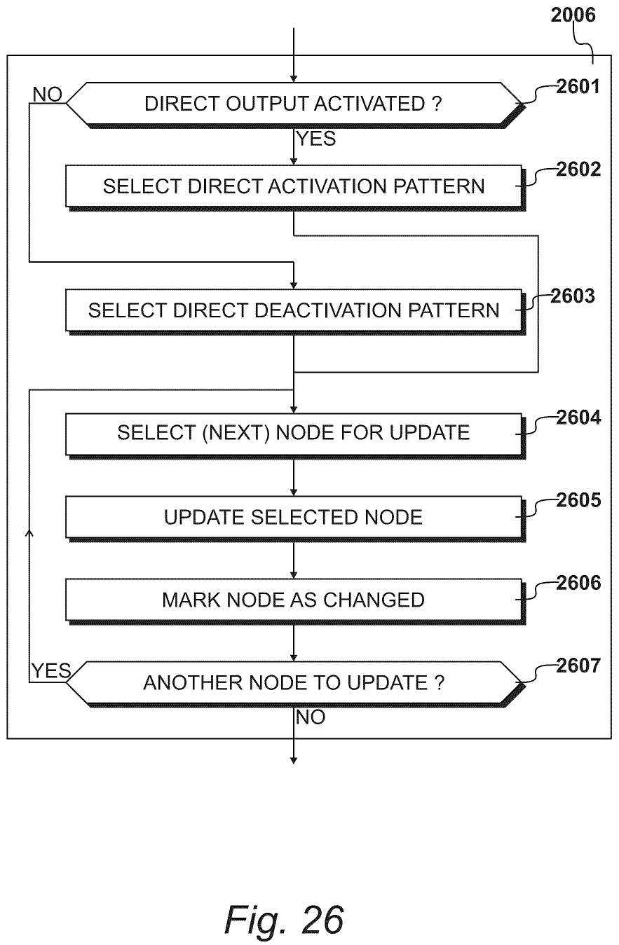

### FIG. 26

The step 2006 of updating a direct masking layer shown in FIG. 20, is detailed in FIG. 26. At step 2601 a question is asked as to whether the modifying request requires a direct masking layer to be activated. If so, control is directed to step 2302 where the direct masking layer's activation pattern is selected. If not, the direct masking layer's deactivation pattern is selected at step 2603. Taking the example of direct masking layer 1205, at step 2604 the first node in the direct layer 1205 is selected for update. At step 2605 the selected node is updated with the appropriate value from the pattern selected at step 2602 or step 2603.

At step 2606 the updated node is marked as changed, by setting a flag within the data structure of the layer 1205. As with the layers below it, this setting of a changed flag triggers setting of the changed flags for all dependent nodes in layers above the direct masking layer. At step 2606 a question is asked as to whether there are any remaining nodes to update. If so, control is directed back to step 2604 so that all nodes in the direct layer 1205 are updated with the pattern selected at step 2602 or step 2603.

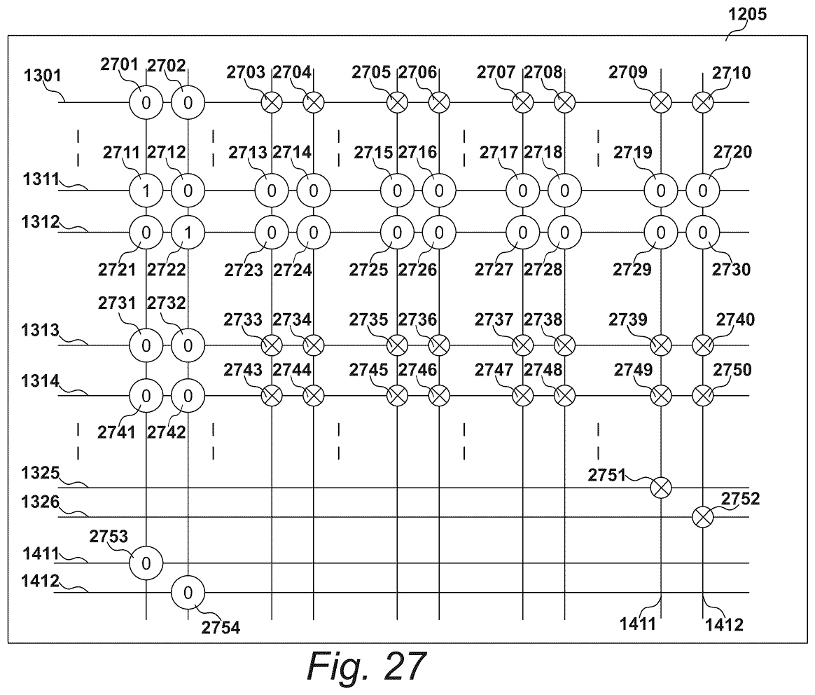

### FIG. 27

The activation pattern selected at step 2602 in FIG. 26 is detailed in FIG. 27. The pattern shown is used for activation of direct masking layer 1205. This pattern is selected when direct switch 702 is activated. Nodes 2701 and 2702 are updated with values of zero. Nodes 2703 to 2710 are pass-through nodes implemented using a null value.

In order to directly transfer playback input channel 1311 to main output 1319, node 2711 is set to 1.0, masking and overriding any values from layers below. The remaining nodes 2712 to 2720 for input 1311 are masked with zero values, ensuring that playback of input 1311 is not distributed to any other output. Similarly, playback input channel 1312 supplies main output 1320 by setting node 2722 to 1.0 and other nodes 2721, 2723 to 2730 to zeros. Other inputs follow the pattern shown for input 1301, as indicated by nodes 2731 to 2750. Nodes 2751 and 2752 are always pass-through nodes. Nodes 2753 and 2754 are masked to zero because, when the main outputs 1319 and 1320 are used as direct playback outputs, AFL functionality is not implemented.

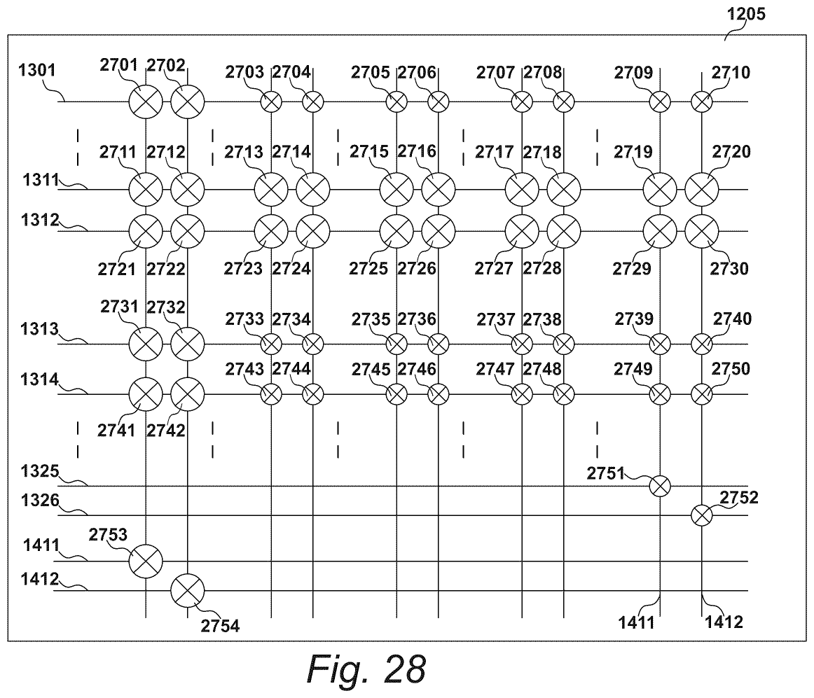

### FIG. 28

The deactivation pattern selected at step 2603 in FIG. 26 is detailed in FIG. 28. The pattern shown is used for deactivation of direct masking layer 1205. This pattern is selected when direct switch 702 is deactivated. All nodes 2701 to 2754 are set as pass-through nodes. Nodes with large diameters in the figure are those that change with respect to the activated state for the layer 1205 which is shown in FIG. 27.

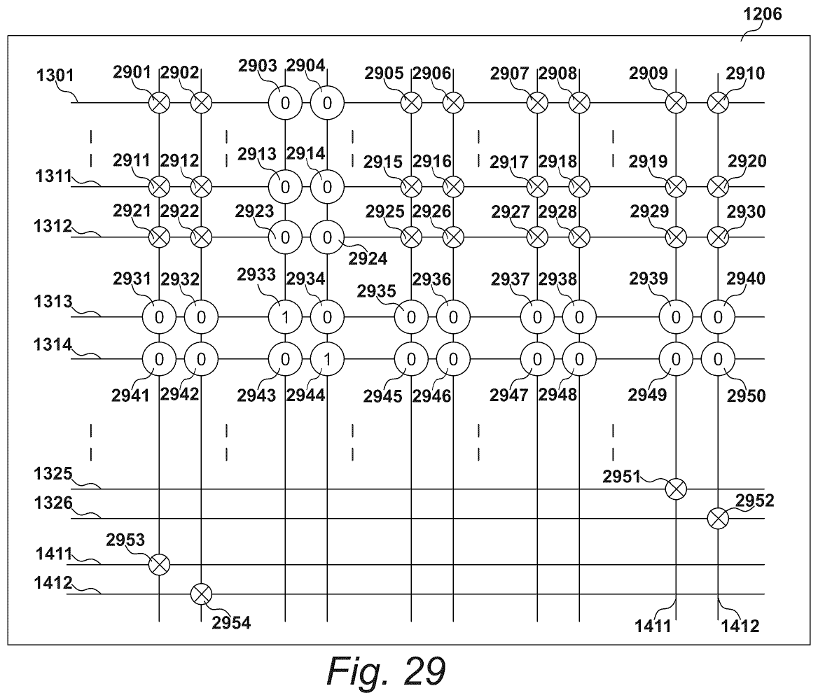

### FIG. 29

When activating a different direct masking layer, a slightly different activation pattern is used. The activation pattern selected at step 2602 in FIG. 26 is detailed in FIG. 29 for an example of direct masking layer 1206. Nodes 2901 and 2902 are pass-through nodes. Nodes 2903 and 2904 are updated with values of zero. Nodes 2905 to 2910 are pass-through nodes. Nodes 2911, 2912, and 2915 to 2922 are pass-through nodes, whereas nodes 2913, 2914, 2923 and 2924 are given the masking values of zero. Nodes 2925 to 2930 are pass-through nodes.

Playback input 1313 contributes no signal to either of the main outputs 1319, 1320 so nodes 2931 and 2932 are set to masking values of zero. Node 2933 is set to 1.0 so playback input 1313 supplies output 1321. Nodes 2934 to 2940 are set to zero. A similar pattern is repeated for playback input 1314 and nodes 2941 to 2950, with the exception that node 2944 is set to 1.0 to distribute playback input 1314 to output 1322.

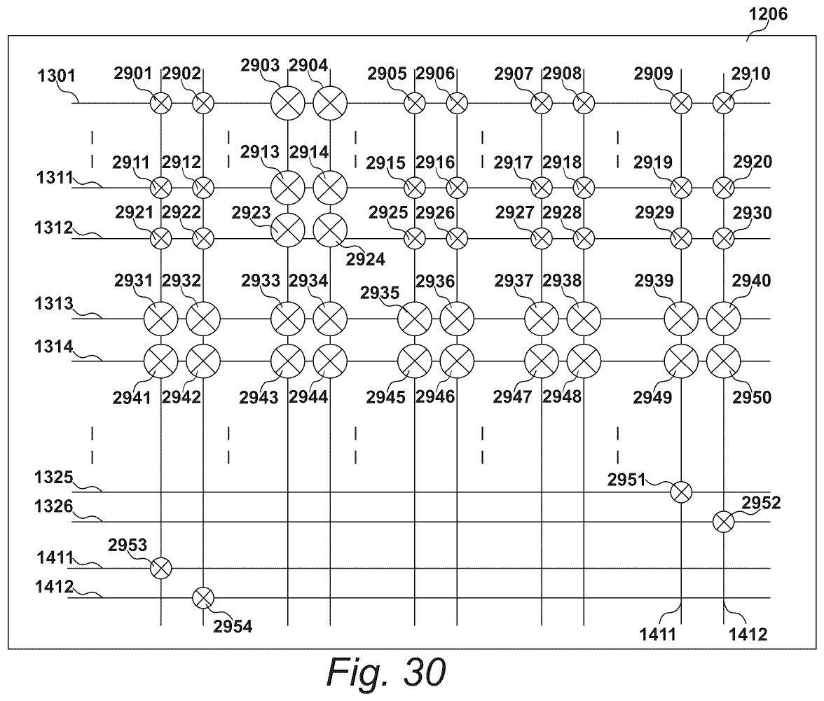

### FIG. 30

Using the same example of direct masking layer 1206, the deactivation pattern selected at step 2603 in FIG. 26 is detailed in FIG. 30. All nodes 2901 to 2954 are set as pass-through nodes.

In an embodiment, layers 1205 to 1208 are implemented as a single layer. In this alternative embodiment, nodes are activated or deactivated in response to a modifying request in the user input signals 1211 in accordance with the desired functionality. Such layer activation is specific to the modifying request, and layer activation and deactivation is therefore not limited to one of two possible states. In other embodiments, layer activation may be implemented with any degree of granularity.

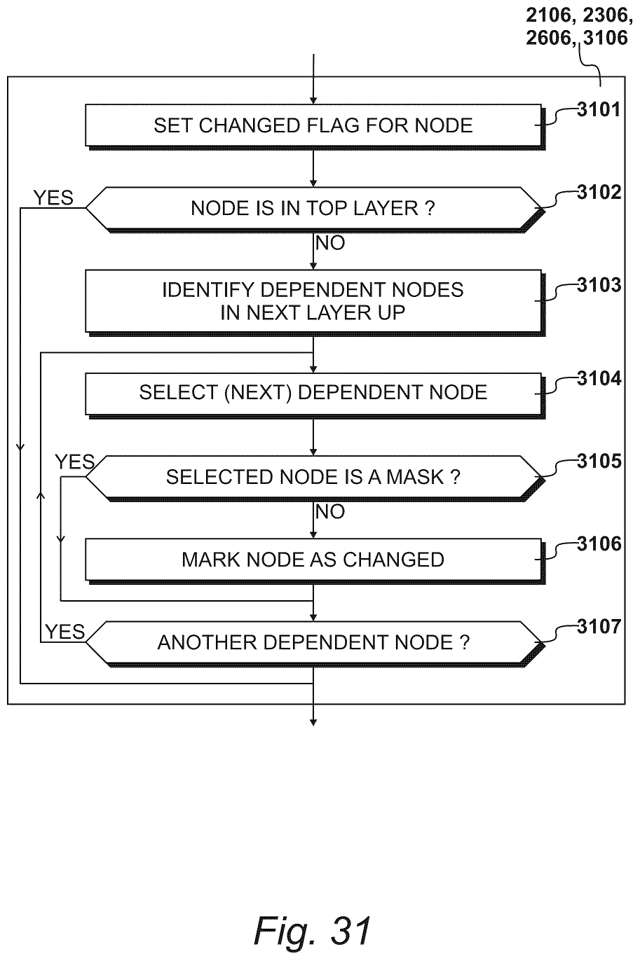

### FIG. 31

Steps 2106, 2306 and 2606 of marking a node as changed, shown in FIGS. 21, 23 and 26 respectively, are substantially the same step performed in different contexts. This is detailed in FIG. 31. At step 3101 the changed flag for the selected node is set. At step 3102 a question is asked as to whether the node is in the top layer 1210. If not, control is directed to step 3103 where dependent nodes in the next layer up are identified. Usually there is only one dependent node, and this has the same X and Y node coordinates, but in the layer above. However, there are exceptions.

At step 3104 the first of the dependent nodes identified at step 3103 is selected. At step 3105 a question is asked as to whether the selected node is a mask. If so, changes are masked by the layer above, and the change is not propagated to the next layer up. Alternatively, at step 3106, the selected node is marked as changed. step 3106 is a recursive step that calls the steps of FIG. 31 that contains it. This recursion results in propagation of the state of change to higher and higher layers. At step 3107 a question is asked as to whether all dependent nodes have been selected. If not, steps 3104 to 3107 are repeated until this is the case. Usually, the loop only contains one iteration.

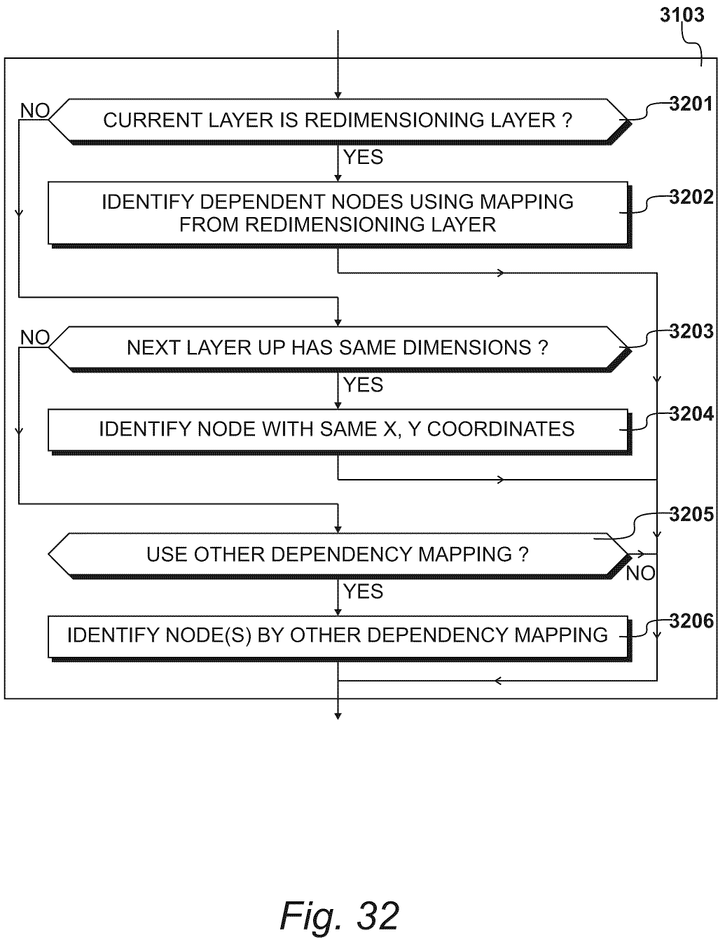

### FIG. 32

The step 3103 of identifying dependent nodes in the next layer up, shown in FIG. 31, is detailed in FIG. 32. At step 3201 a question is asked as to whether the current layer is the re-dimensioning layer 1209. If so, at step 3202 dependent nodes are identified using a mapping in the re-dimensioning layer. Alternatively, at step 3203 a question is asked as to whether the layer above has the same number of dimensions as the current layer. Most layers are paired in this way, including layers 1203 to 1209. If so, at step 3204 one dependent node is identified in the layer above, having the same X, Y coordinates as the current node.

In an embodiment, other types of layers may be implemented. Therefore, if the step 3203 is answered in the negative, control is directed to step 3205 where a question is asked as to whether another kind of dependency mapping should be applied. If so, control is directed to step 3206 where dependent nodes are identified in accordance with the required dependency mapping.

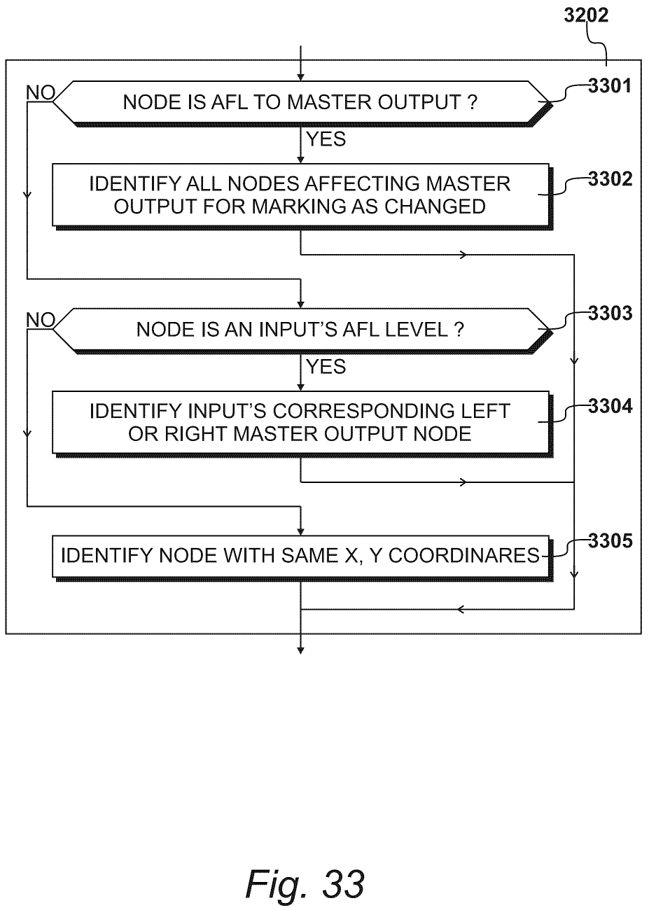

### FIG. 33

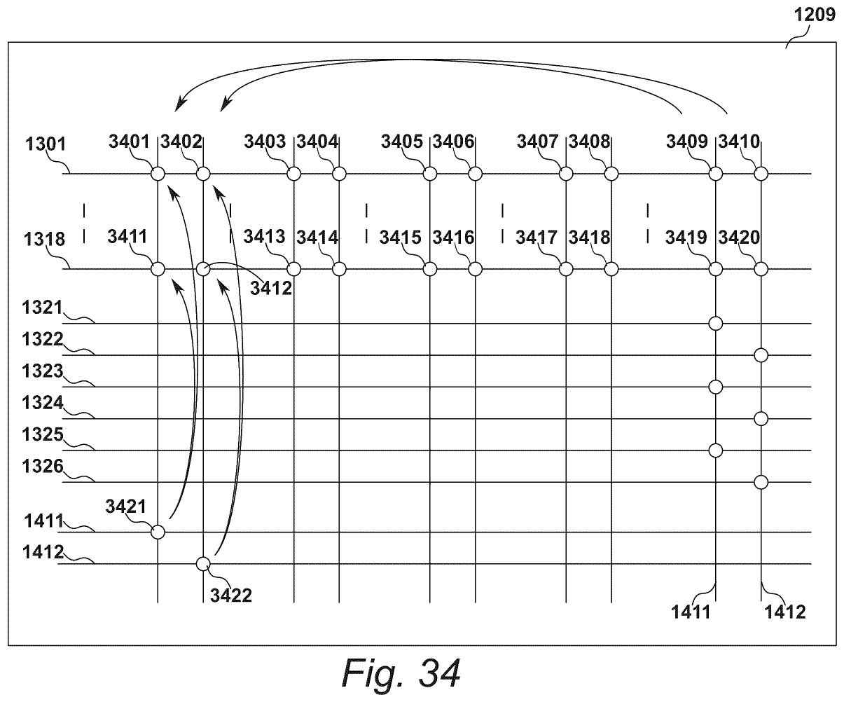

The step 3202 of identifying dependent nodes using a mapping from the re-dimensioning layer, shown in FIG. 33, is detailed in FIG. 34. At step 3301 a question is asked as to whether the selected node distributes the AFL bus to a main output. In other words, is the selected node either node 2427 or 2428. If so, at step 3302 all nodes affecting the master output are selected for marking as changed. This will include, for example, nodes 2401, 2402, 2411 and 2412.

Alternatively, at step 3303 a question is asked as to whether the selected node is an input's AFL level. An example is any of nodes 2409, 2410, 2419 or 2420. If so, at step 3304 the input's corresponding left or right master output node is identified. For example, if the selected node is node 2409, the identified node will be node 2401. If the selected node is node 2420, the identified node will be node 2412.

Finally, if neither of the mappings of steps 3302 or 3304 is required, a direct mapping is used at step 3305, where a single node is identified in the layer above, having the same X, Y coordinate.

### FIG. 34

The effect of the mapping performed by the steps shown in FIG. 33 is illustrated in FIG. 34, which shows the two-dimensional matrix of function nodes 3401 to 3422 of the re-dimensioning layer. Changes in nodes below node 3401, such as nodes 2901, 2701, 2401 and 1401 propagate upwards to node 3401. However, changes in nodes below node 3409 also cause node 3401 to be marked as having changed. Changes in nodes below node 3421 cause nodes 3401 and 3411 to be marked as having changed.

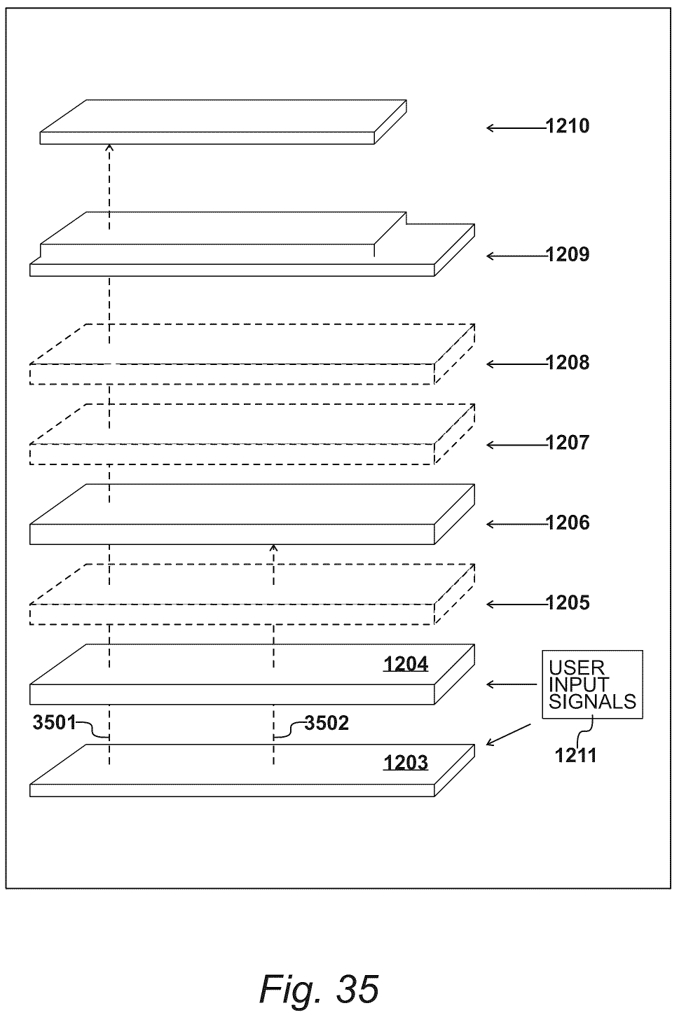

### FIG. 35

The recursive setting of change flags performed by the steps of FIG. 31 is illustrated in FIG. 35. User input signals 1211 contain modifying requests that result in updates of the user-defined distribution 1203 and also, potentially, of other layers. In the example shown in FIG. 35, the AFL masking layer 1204 is updated and activated. Also, the direct masking layer 1206 is activated. A first change in the user-defined distribution 1203 propagates upwards 3501 all the way to the top layer 1210, indicating to a node in the top layer that its value is now out of date. A second change in the user-defined distribution 1203 propagates 3502 upwards, but only as far as one of the direct masking layers 1206, where it is masked by zero-value node in the activated layer.

This masked propagation of changes provides a mechanism that anticipates a requirement for propagating gain values through the stack of layers, so that only those changes which can affect the top layer 1210 will be calculated. This mechanism for anticipating a requirement reduces the number of cycles of the CPU 1024 needed to update the transformed distribution 1210. Potentially this may reduce the CPU cycles to zero, even though the user modifies some elements of the virtual mixer 400.

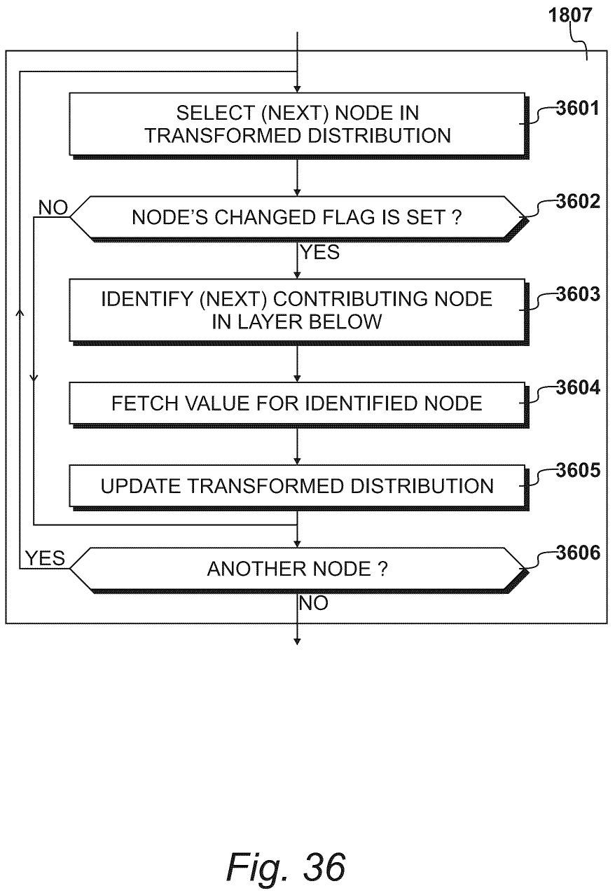

### FIG. 36

Step 1807 of transforming the user-defined distribution, shown in FIG. 18, is detailed in FIG. 36. At step 3601 the first node in the transformed distribution is selected. At step 3602 a question is asked as to whether the node's changed flag has been set, as a result of the steps performed in FIG. 31. If so, at step 3603 the next contributing node in the layer below is identified, and at step 3604 a numerical value for the gain of the identified node is obtained by reaching down through the layers below. Step 3602 may be understood as selecting a gain for propagation through the layers 1204 to 1209.

At step 3605 the node of the transformed distribution 1210 is updated with the calculated numerical value for its gain. At step 3606 a question is asked as to whether any additional nodes remain to be checked. If so, control is directed to step 3601. The steps of FIG. 36 are repeated until each node in the transformed distribution 1210 has been selected, checked for changes, and updated if necessary.

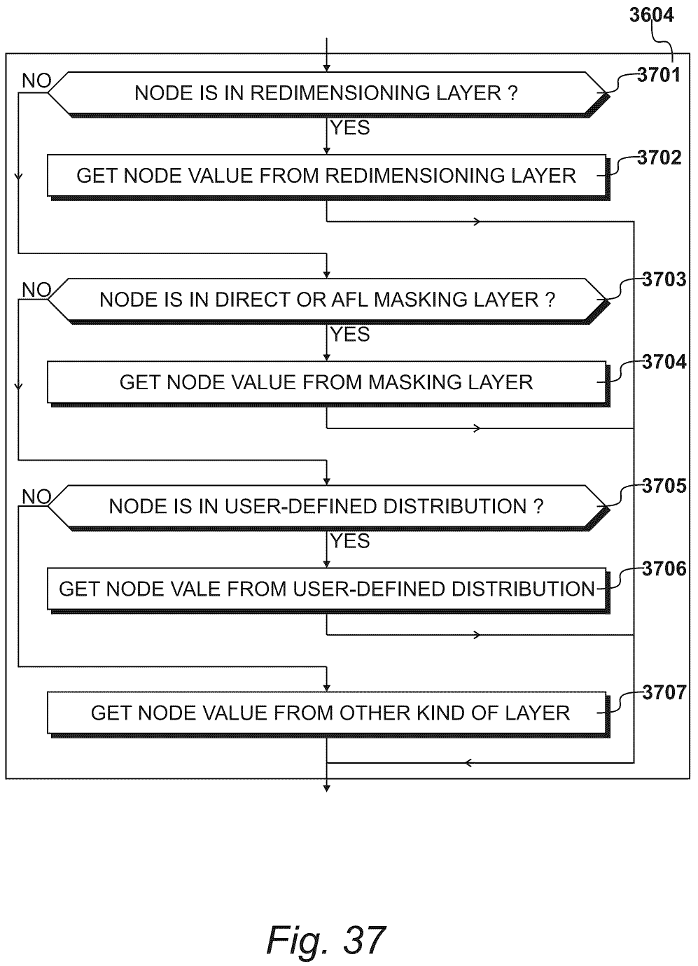

### FIG. 37

The step 3604 of fetching a value for an identified node, shown in FIG. 36, is detailed in FIG. 37. At step 3701 a question is asked as to whether the selected node is in the redimensioning layer 1209. If so, at step 3702 a node value is obtained from the redimensioning layer. Alternatively, at step 3703 a question is asked as to whether the node is in a direct or AFL masking layer. If so, at step 3704 a node value is obtained from the masking layer, which can be any of layers 1204 to 1208. As a further alternative, at step 3705 a question is asked as to whether the node is in the user-defined distribution 1203. If so, at step 3706 a node value is obtained from the user-defined distribution 1203. Finally, for other embodiments, if the node is in another kind of layer, at step 3707 a node value is obtained from the respective layer of the alternative embodiment.

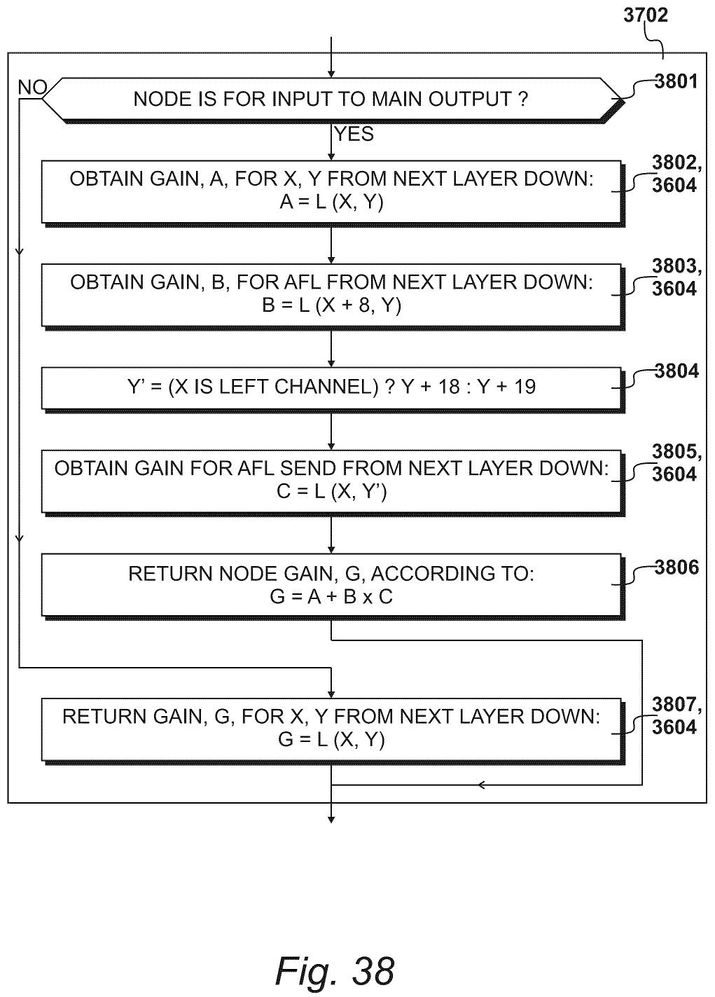

### FIG. 38

Step 3702 for obtaining a node value from the re-dimensioning layer, shown in FIG. 37, is detailed in FIG. 38. At step 3801 a question is asked as to whether the node distributes an input 1301 to 1318 to the left or right main output 1319 or 1320. Examples of such nodes are any of 3401, 3402, 3411 or 3412 shown in FIG. 34. If so, control is directed to steps 3802 onwards. At step 3802 the gain, A, for a node with the same X, Y coordinates, is obtained from the next layer down. The gain, A, is obtained using a recursive call to instructions for step 3604, which are detailed in FIG. 37.

At step 3803 the gain, B, for AFL level from the next layer down is obtained using offset node coordinates X+8 and Y, such that, for example, nodes below node 3409 or node 3410 will be used to calculated the value of gain B. A recursive call to instructions for step 3604 is used to obtain the value of gain B.

At step 3804 a modified Y index, Y′, is defined as Y+18 or Y+19 depending on whether X is a left or right channel. At step 3805 the gain, C, is calculated with a recursive call to instructions for step 3604 for a node in the next layer down having the coordinates X and Y′. This obtains gains from nodes below node 3421 or node 3422.

At step 3806 gains A, B and C are combined to define G, given by G=A+B×C. The effect of this can best be appreciated with reference to FIG. 22. Node 1401 provides a value of 0.7, but this is masked to zero by node 2401 as shown in FIG. 24. Node 1409 provides a value of 0.7 for gain B. Node 1423 provides a value of 1.0 for gain C. The gain G, is 0.0+0.7×1.0, which is 0.7. The effect of this is the implementation of an AFL bus without there being the need to transfer signals over such a bus. Looking again at FIG. 22, node 2201 provides a gain of 0.2, but node 2411 shown in FIG. 24 masks this with a value of zero. Node 2209 is set to zero because input 1318 doesn't have its solo switch activated, with the result that none of its signal is sent to the main output.

One can see the effect of a deactivated AFL masking layer as shown in FIG. 25, in which the masking does not occur, and gain A, for input 1318 is then set to 0.2, resulting in this input being heard in the main output 1319.

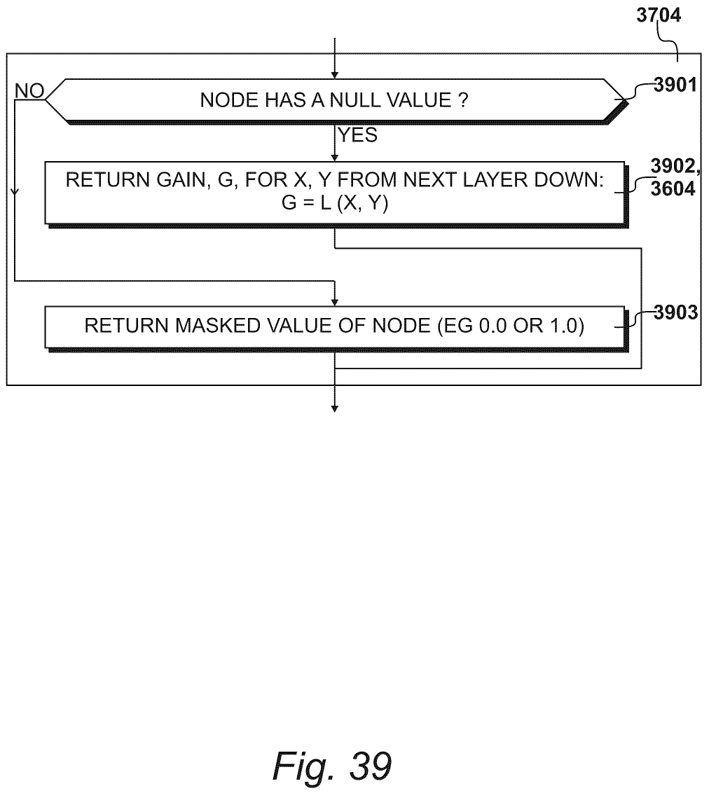

### FIG. 39

The step 3704 of obtaining a node gain value from a masking layer, shown in FIG. 37, is detailed in FIG. 39. At step 3901 a question is asked as to whether the node has a null value. If so, at step 3902 the gain is obtained from the node in the next layer down, having the same X, Y coordinates, using a recursive call to instructions for step 3604. Alternatively, if the node actively masks layers below it, at step 3903 the masked value is returned. A masked value is usually 0.0 or 1.0. In an embodiment, other masking constants may be used to override the gains of nodes in layers below the masking layer.

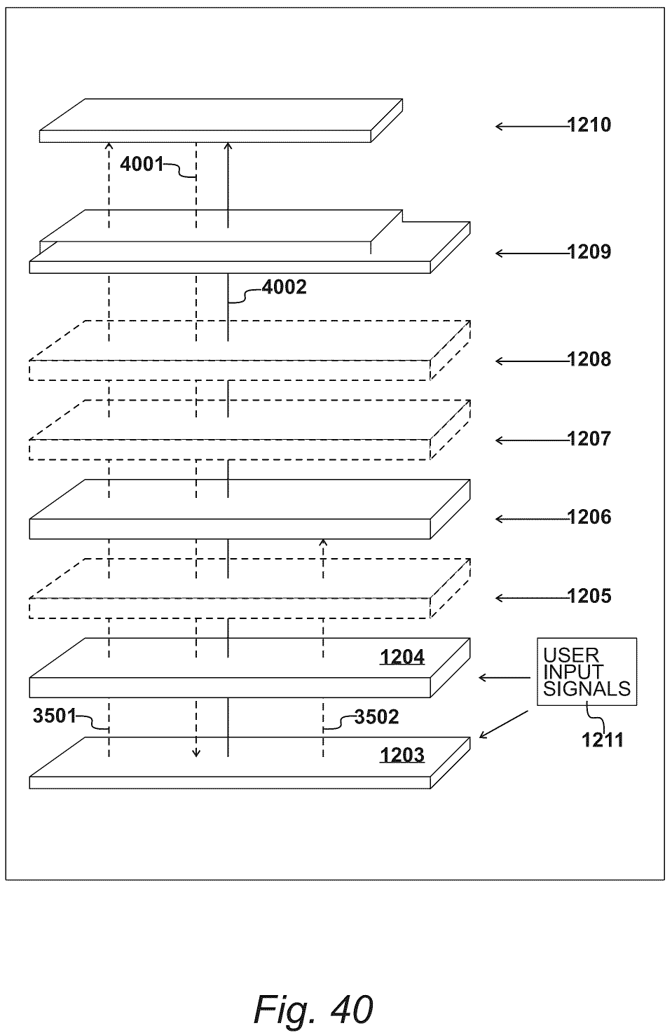

### FIG. 40

The effect of the steps of FIG. 18 is illustrated in FIG. 40. User input signals 1211 contain modifying requests that result in the recursive setting of change flags 3501 and 3502. Some of these changes 3502 are masked by one of the layers 1206, thereby making it unnecessary to recalculate distribution gains that would otherwise be affected by those changes 3502. Other changes 3501 reach the top layer 1210. When transforming the user-defined distribution, it's only necessary to perform calculations for gains of nodes marked by 3501 as having been changed in the top layer 1210, thereby anticipating a requirement.

Working from the top layer downwards 4001, the steps of FIG. 36 recursively reach further and further down through the layers, either reaching a masking constant or a value in the user-defined distribution 1203. The value is then passed upwards 4002 to the top layer, where it is used to update the respective node in the transformed distribution 1210 at step 3605. This filtering or processing of gains through the layers may be considered a form of propagation of gains. This propagation is selective and dependent upon modifying requests identified within user input signals 1211. The selective propagation of gains is performed in response to the requirement anticipated by the conditional propagation of changes 3501, 3502 performed by the layers 1204 to 1209.

The transformed distribution 1210 is initially established by processing the user-defined distribution 1203 through the layers 1204 to 1209 of the transforming stack. Thereafter, user input signals 1211 are received and a modifying request is identified 1804. A function matrix, such as the matrix of layer 1204 is modified, for example by activation 2302 in response to the modifying request. The transformed distribution 1210 is then updated by processing gain factors such as gains 1401 and 1402 from the user-defined distribution 1203 through 4002 at least one layer of the transforming stack 1204 to 1209 in response to the modification 2302. The resulting transformed distribution 1210 is then supplied to a process 1808 for distributing the audio signals.

This process is made especially efficient by the propagation 3101 of a change flag through the layers 1204 to 1209 of the transforming stack of function matrices, thereby ensuring that processing required to implement the transforming stack is minimized. The change is propagated 3101, 3501 so that only changed gains 4002 are subsequently processed by transmission of a distribution gain from a lower layer 1204 through at least one of the intervening layers 1205 to 1209 of the transforming stack.

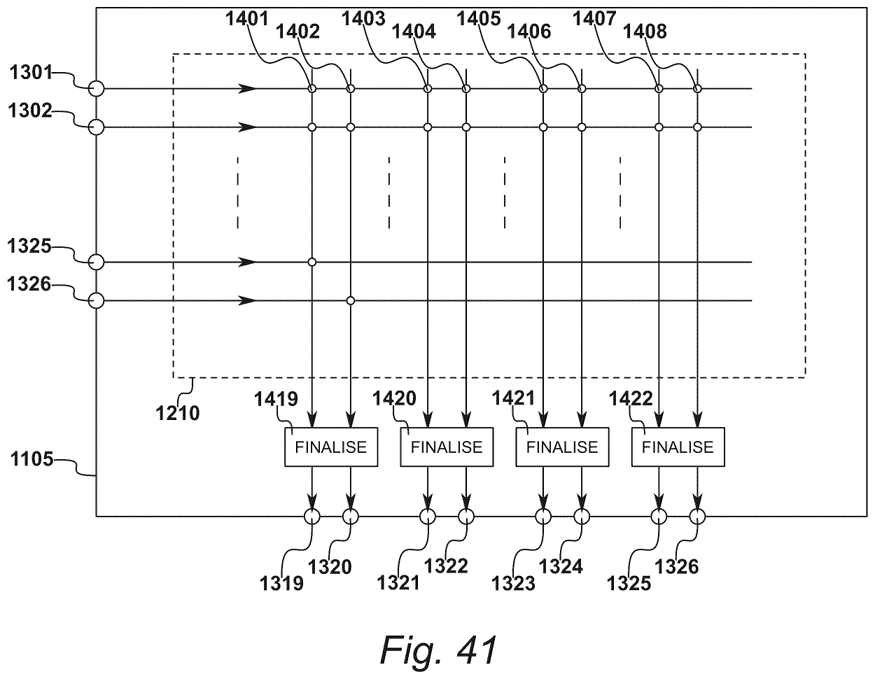

### FIG. 41

The transformed distribution 1210 shown in FIG. 12 is detailed in FIG. 41. It can be seen that the number of nodes in the transformed distribution 1210 is less than that of the user-defined distribution 1203 detailed in FIG. 14. In particular, the left AFL bus 1411 and right AFL bus 1412 are missing, along with their associated nodes. The AFL functionality has been conflated with the other distribution functionality provided by other distribution gains. The equivalent is obtained by simply activating and deactivating layers below the re-dimensioning layer, which is far simpler than providing custom routing logic for each function of the virtual mixer 400.

Two advantages accrue from this. Firstly, the complexity of implementation of the distribution instructions 1105 is greatly reduced. This results in greater stability of the audio interface 101, lower cost of development and shorter time to market. Secondly, a cheaper CPU 1024 can be used, due to the smaller number of multiplications performed by the CPU 1024 to distribute the input signals 1301 to 1318, and due to the predictability of instructions being executed upon it. The reduction in multiplications occurs as a result of propagating the user-defined distribution 1203 through the re-dimensioning layer 1209 to generate the transformed distribution 1210.

The re-dimensioning layer 1209 can be considered a virtual bus-applying layer, in that it applies a virtual bus from a larger distribution 1203 to a smaller distribution 1210, removing virtual elements and improving efficiency.

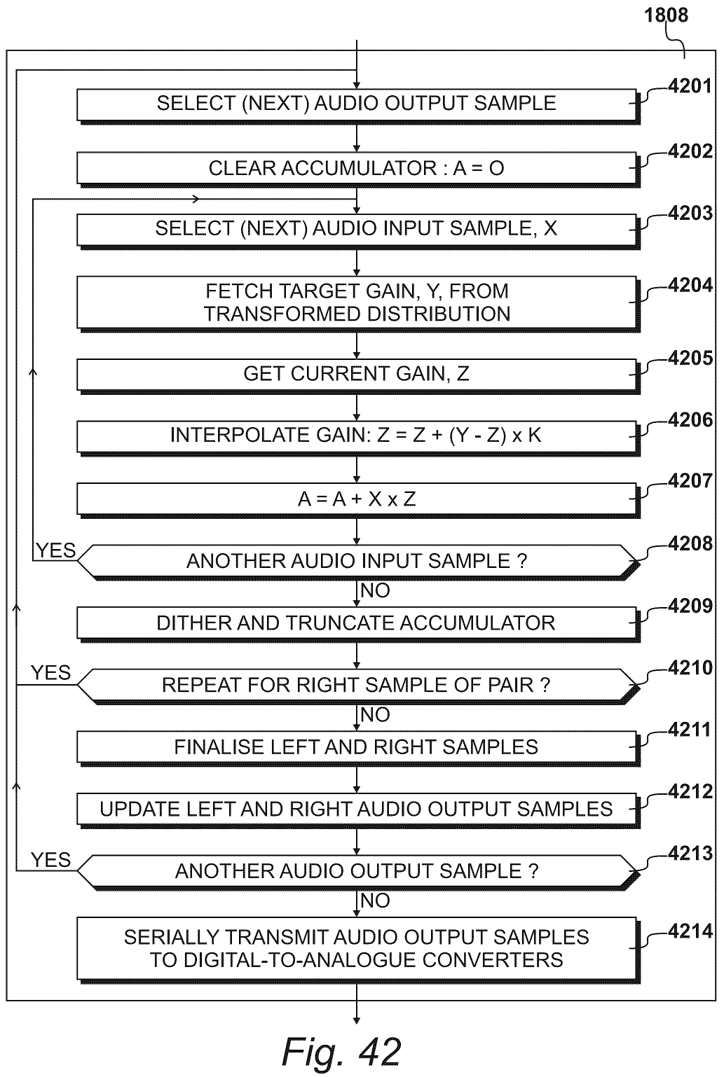

### FIG. 42

The step 1808 of distributing audio inputs to audio outputs, shown in FIG. 18, is detailed in FIG. 42. At step 4201 the first audio output sample 1319 is selected for calculation. At step 4202 an accumulator, A, is set to zero. At step 4203 the first audio input sample 1301 is selected for distribution. At step 4204 a target gain, Y, is fetched from node 1401 in the transformed distribution 1210. At step 4205 the current gain for node 1401 is obtained from other data 1214. At step 4206 an interpolation is performed, in which the current gain, Z, is incremented by the product of the difference between Y and Z and an interpolation constant K. The interpolation constant is calculated in response to the audio sampling rate and the number of samples over which interpolation is to be performed, typically resulting in an interpolation duration of a few milliseconds. Once the distribution gain, Z, has been interpolated, it is used at step 4207 to distribute the input sample 1301 to the output sample 1319 by adding the product of X and Z to the accumulator, A.

At step 4208 control is directed back to step 4203 so that other audio input samples 1302 to 1318 can be accumulated in the same way by steps 4204 to 4207. In addition, outputs 1321 to 1326 are also distributed as inputs in order to implement AFL functionality activated by switches 808, 813 and 817.

Once all the input samples have been accumulated for the first output 1319, control is directed to step 4209, where the sixty-four-bit accumulator is dithered and truncated to thirty-two bits for subsequent processing and onward transmission. At step 4210 control is directed back to step 4201 to accumulate the right channel output 1320. Once both left and right samples of the output pair 1319 and 1320 have been accumulated, these are finalised at step 4211, which implements the finalizing process 1419, or, on subsequent iterations, one of finalizing processes 1420, 1421 or 1422. At step 4212 the finalised samples are written to output samples 1319 and 1320 respectively, and, on subsequent iterations, to outputs 1321 to 1326.

At step 4213, control is directed back to step 4201 so that the remaining outputs 1321 to 1326 can be updated. Finally, at step 4214, the audio output samples 1319 to 1326 are transmitted in a serial bitstream from the CPU 1024 to the digital-to-analog converters 1010, causing distributed analog signals to be heard on headphones 108, 110 and loudspeakers 115, 116.

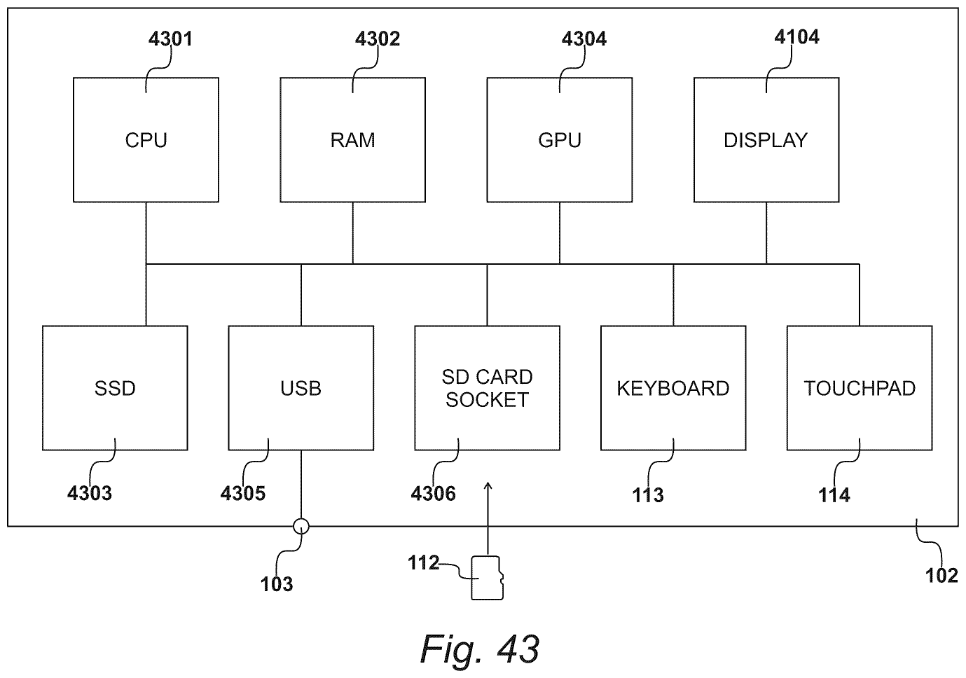

### FIG. 43

In an alternative embodiment, the user-defined distribution 1203 is transformed on a processor in the laptop 102. Hardware components of the laptop computer 102 are shown in FIG. 43. A Central Processing Unit (CPU) 4301 processes instructions and data stored in RAM 4302. Non-volatile instruction and data storage is provided by a five hundred and twelve gigabyte Solid State Drive (SSD) 4303. A Graphics Processing Unit (GPU) 4304 receives instructions and data from the CPU and renders a graphical user interface (GUI) for the virtual mixer 400. The GPU 4304 supplies signals to the laptop's display 104. The CPU 4301 and GPU 4302 are part of an ARM™ M1 system-on-chip (SOC) and are shown and described separately for clarity.

A USB interface 4305 provides the connection 103 to the audio interface 101. An SD card socket 4306 receives the SD card 112 from which virtual mixer instructions can be installed. The laptop 102 also includes the keyboard 113 and touchpad 114, and other peripherals such as a camera, sound card and so on, that are not directly of relevance to the embodiment and have therefore been omitted for clarity.

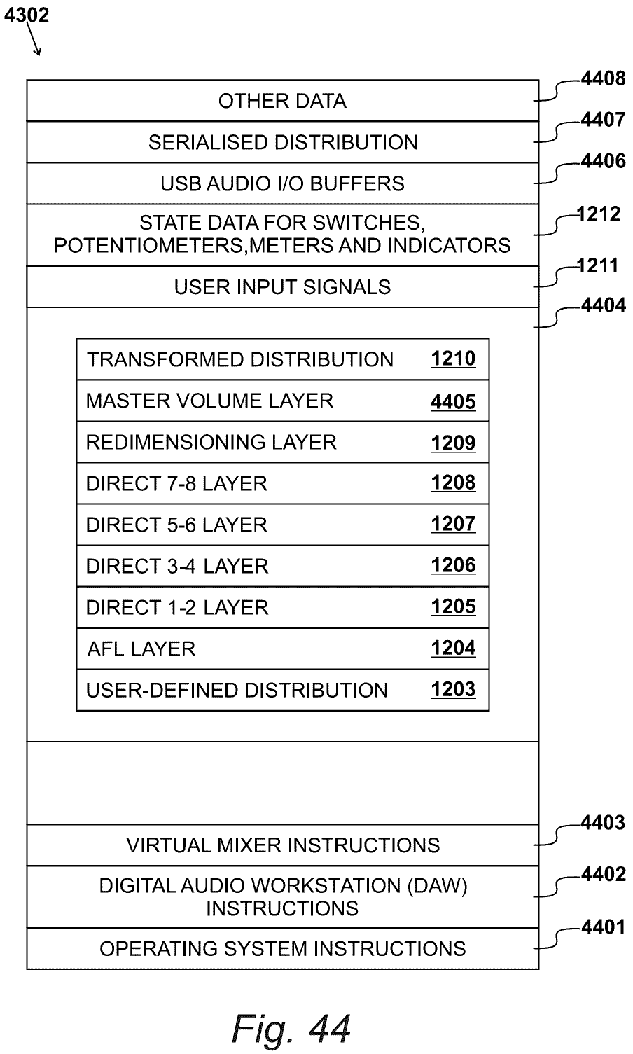

### FIG. 44

Contents of RAM 4302 shown in FIG. 43 during operation of the laptop 102 are detailed in FIG. 44. MacOS™ operating system instructions 4401 provide hardware abstraction and utilities for running applications on the laptop 102. In an embodiment, other operating system instructions may be used. Digital Audio Workstation (DAW) instructions 4402 receive audio samples from the audio interface 101 via the USB connection 103 and record the musicians' performances on the SSD 4303. Virtual mixer instructions 4403 provide a graphical user interface for controlling the audio interface 101 as shown in FIG. 4.

Data contents of RAM 4302 in this alternative embodiment include layers 4404 including the user-defined distribution 1203, the AFL masking layer 1204 and direct masking layers 1205 to 1208. A master volume layer 4405 is provided above the re-dimensioning layer 1209 and below the transformed distribution 1210. RAM 4302 also includes user input signals 1211 from physical controls 1045 on the audio interface 101 received via the USB connection 103 and virtual controls shown on the display 104. State data 1212 includes data representing the state of real and virtual switches, potentiometers, controls, meters and other indicators. USB audio I/O buffers 4406 store buffered audio data received from and due to be sent to the audio interface 101. Contents of RAM 4302 also include a serialized distribution 4407. Other data 4408 includes additional data and variables used by the instructions 4401, 4402 and 4403 during their execution.

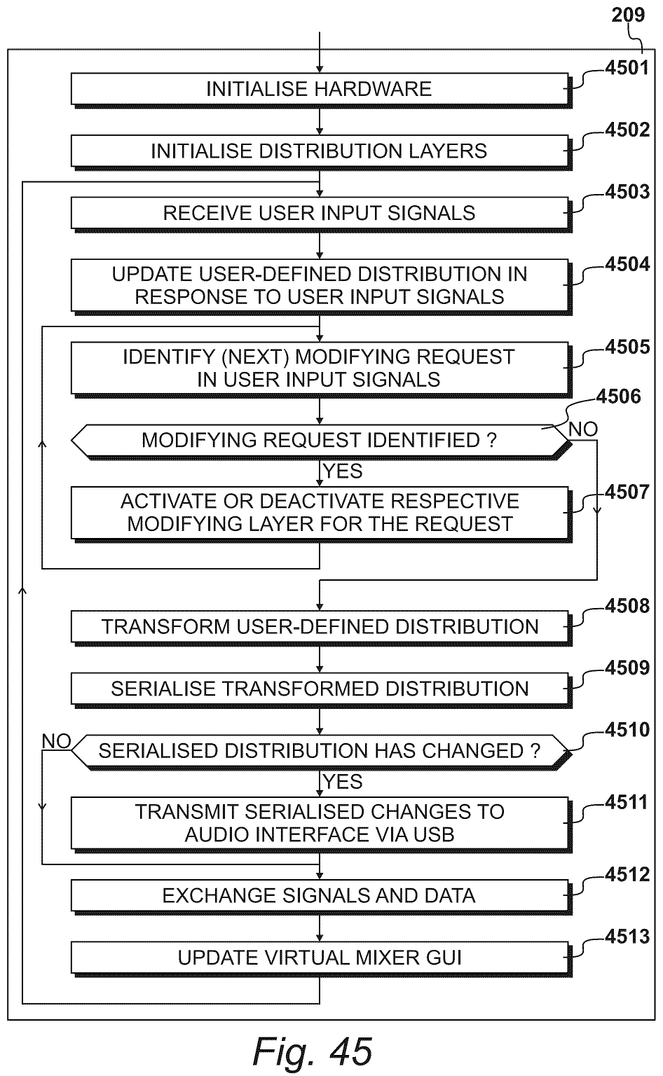

### FIG. 45

The step 209 of executing virtual mixer instructions, shown in FIG. 2, is detailed in FIG. 45 in accordance with the alternative embodiment in which the user-defined transformation 1203 is transformed on the CPU 4301 of the laptop 102. Step 209 executes the virtual mixer instructions 4403 shown in FIG. 34. At step 4501 hardware components of the laptop 102 are initialized along with data structures used in association with the virtual mixer instructions 4403. This includes the graphical user interface shown on the display 104 and USB communications with the audio interface. At step 4502 the layers 4404 are initialized. At step 4503 user input signals 1211 are received. User input signals 1211 can be generated by the keyboard 113 or touchpad 114 of the laptop 102 or by the switches and controls of the audio interface 101 transmitted to the laptop 102 via the USB connection 103.

At step 4504 the user-defined distribution 1203 is updated in response to the user input signals 1211. At step 4505 an attempt is made to identify a modifying request in the user input signals 1211. If successful, step 4506 directs control to step 4507 where a transforming layer (1204 to 1208) is activated or deactivated in response to the modifying request. Steps 4505 to 4507 are repeated until there are no further modifying requests that can be identified in the user input signals 1211 and control is directed to step 4508 where the user-defined distribution 1203 is transformed. Instructions for step 4508 operate in accordance with the description for step 1808, but these instructions are executed by the laptop CPU 4301 rather than the audio interface CPU 1024.

At step 4509 the transformed distribution 1210 is serialized. At step 4510 a question is asked as to whether the serialized distribution contains any changes as a result of the transformation performed at step 4508. This is determined by checking the state of the changed flags contained in the nodes of the transformed distribution. If the serialized distribution has any changes, at step 4511 changed parts of the serialized transformed distribution 3407 are transmitted to the audio interface 101 via the USB connection 103, thereby, in effect, transmitting the transformed distribution 1210. Alternatively, the serialized transformed distribution 4407 will not be transmitted if there are no changes to it.

Layers 1204 to 1208 are masking gain layers that, when activated, are able to mask changes that occur in layers below them. For example, the user 109 may adjust the fader 518 while another channel is being listened to on the AFL bus. Adjustments of fader 518 then have no effect, because the input channel's gain is masked by the AFL layer 1204. A direct consequence of this is that changes in the transformed distribution 1210 are only transmitted when absolutely necessary. This reduces the load on the laptop CPU 4301 and the USB connection 103, improving stability of the laptop operating system 4401 and reducing power consumption on both the laptop 102 and the audio interface 101.

At step 4512 signals and data are exchanged with the audio interface 101, including updating state data 1212 in accordance with the controls of the audio interface 101 using data received from it by the USB connection 103. At step 4513 the graphical user interface components of the virtual mixer are updated. Control is then directed back to step 4503, and steps 4503 to 4513 are executed by the CPU 4301 continuously until the user closes the virtual mixer application 400.

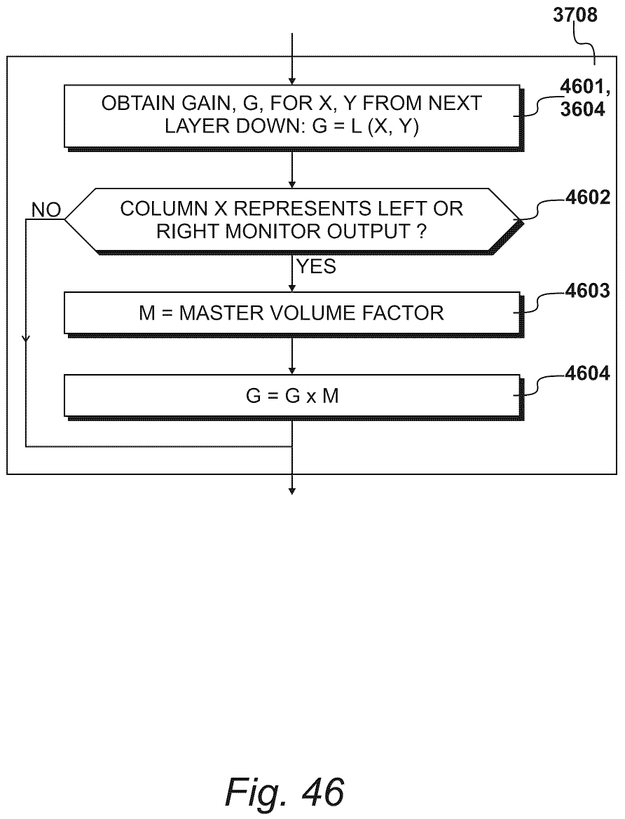

### FIG. 46

In an alternative embodiment, the master volume layer 4405 is provided in addition to the other types of layers that have already been described in detail. The master volume layer 4405 is an example of a volume adjusting layer. The master volume layer 4405 is updated at step 3707 of FIG. 37, using transformation instructions 1807 executed by the laptop CPU 4301. Instructions for propagating gains through the master volume layer 4405 are detailed in FIG. 46.

At step 4601 the gain, G for a node at column X and row Y is obtained from the next layer down. Step 4601 is a recursive call to the instructions of step 3604 detailed in FIG. 37. At step 4602 a question is asked as to whether column X represents either left or right monitor output 1319 or 1320. If not, this completes the steps for calculating the gain, and the value of G is returned. Alternatively, control is directed to step 4603, where a variable M is assigned a master volume factor based on the position of the master volume control 902 of the audio interface. M takes a fractional value in the range is zero to four. At step 4604 the gain G is updated with the product of G and M, and the resulting value is returned.

It will be appreciated that the steps of FIG. 46 make the multiplications 1702, 1706 for the finalizer 1419 shown in FIG. 17 unnecessary, and the master volume layer 4405 reduces the computational load of the CPU 1024 of the audio interface by a modest but useful amount. The savings resulting from the use of layers of this kind combine to open up new functional possibilities without increasing the cost of the hardware components of the audio interface 101.

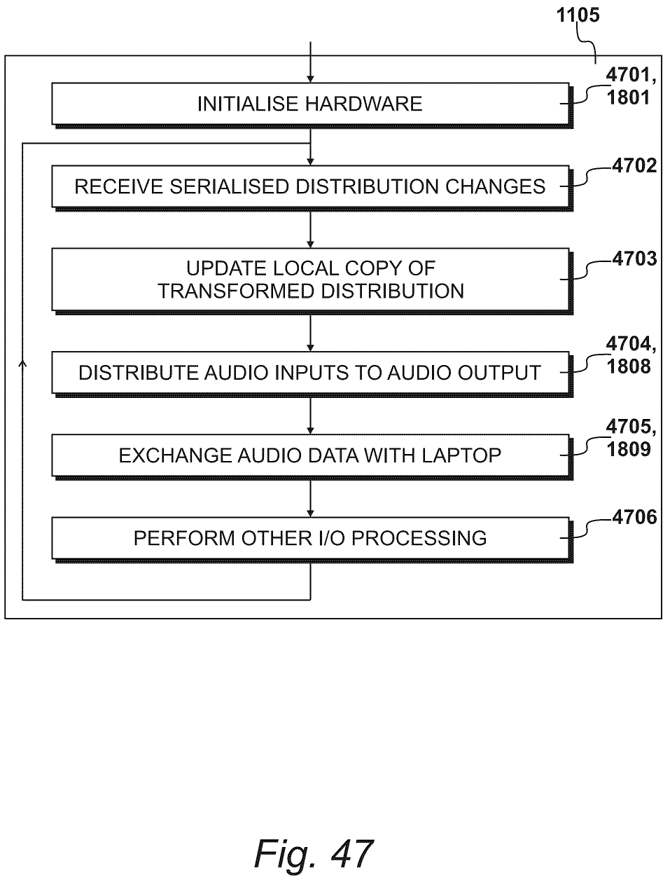

### FIG. 47

In the alternative embodiment, step 210 of executing firmware instructions 1105 is implemented as shown in FIG. 47. At step 4701 hardware components of the audio interface 101 are initialized along with data structures used in association with the hardware components. Step 4701 is substantially the same as step 1801 already described. At step 4802 changes in the serialized distribution 3407 are received from the laptop 102 via the USB connection 103. At step 4703 a local copy of the transformed distribution 1210 is updated from the distribution received at step 4702. Given that gains in the serialized distribution 4407 are only transmitted when absolutely necessary, steps 4702 and 4703 are only performed if one or more serialized distribution gains have been received via the USB connection 103. If no gains from the serialized distribution 4407 are received, the local copy of the transformed distribution 1210 remains unchanged and is used in step 4704.

At step 4704 audio inputs are distributed to audio outputs in accordance with step 1808 previously described with reference to FIG. 42. At step 4705 audio data is exchanged with the laptop 102. Output samples 1311 to 1318 are also received from the laptop 102 at step 4705. Step 4705 operates similarly to step 1809 previously described.

At step 4706 other input and output processing is performed, including calculating and supplying output meter levels to the laptop 102 for display on the virtual mixer 400 as shown in FIG. 4. Step 4706 also includes receiving additional control data for calculating finalisation 1419 to 1422 and setting LEDs on the front panel of the audio interface 101. After step 4706 is complete, steps 4702 to 4706 of FIG. 38 are repeated until the audio interface 101 is switched off.

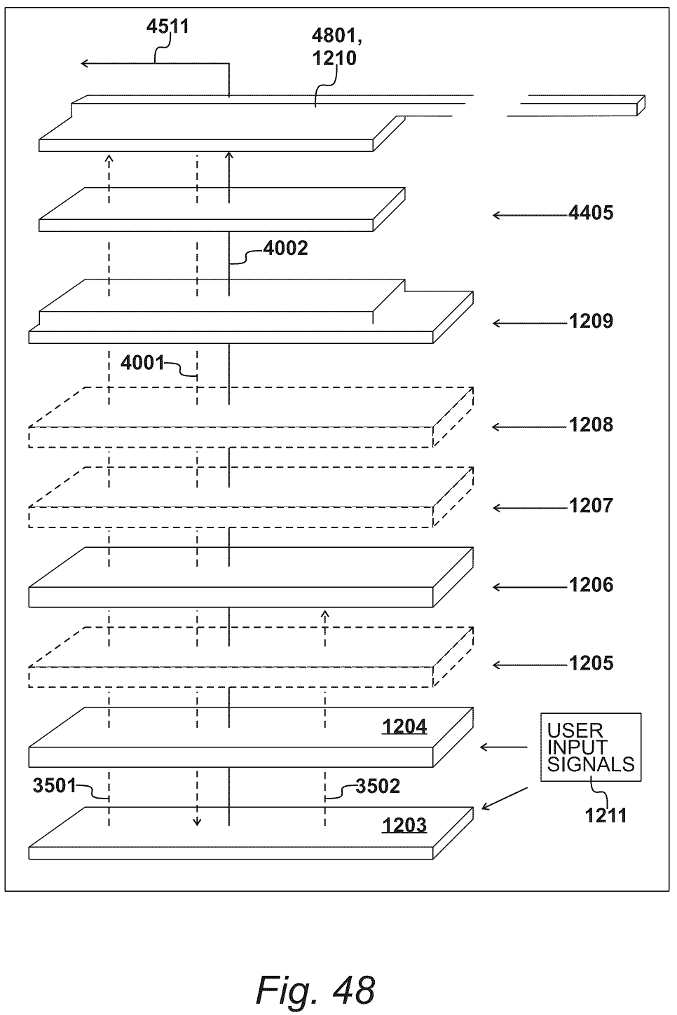

### FIG. 48

In an embodiment, the serialization performed at step 4509 in FIG. 45 is implemented by a serializing distribution layer. This is illustrated in FIG. 48. The top layer is a serializing layer 4801 that includes the transformed distribution 1210. The input of the serializing layer 4801, as represented by its lower surface, has the same dimensions X, Y, as the layer below it, the master volume layer 4405. The master volume layer 4405 has the same dimensions as the upper surface of the re-dimensioning layer 1209 used to conflate the AFL bus with other distribution gains. Given input dimensions X and Y, the output of the serializing layer 4801, as represented by its upper surface, has one dimension of size X times Y. The serializing layer 4801 is a two-dimensional matrix of function nodes in which the serialized transformed distribution is supplied from a mapping of the two-dimensional nodes of which the layer 4801 is comprised.

In this alternative embodiment, the serialized distribution 4407 is generated in the serializing layer 4801 by propagating 4002 gains originating in the user-defined distribution 1203 through the layers 1204 to 1209 and 4405 below it and the serializing layer 4801.

A request for a matrix gain made at step 3603 in FIG. 36 propagates downwards 4001 to retrieve the changed value. The requested gain then propagates upwards 4002 through each modifying layer 1204 to 1209 and 4405, potentially being modified by one or more of these layers, and finally reaching the transformed distribution 1210, which is then serialized. It will be appreciated that values that do not change as a result of masking 3502 will not be propagated 4002, due to the intelligence of the layers and the way in which changes are flagged and propagated 3501, 3502. This intelligence may be understood as anticipating a requirement to calculate and transmit changed gains, thereby saving CPU cycles, and anticipating a requirement includes excluding a masked propagated change that isn't required. If the serialized distribution is changed as a result of user input signals 1211, the requirement is anticipated, and the changed gains are calculated in response to this requirement by selectively propagating gains from the user-defined distribution 1203 through the layers 1204 to 1210. The resulting changed gains are then supplied 4511 to the audio interface 101 via the USB connection 103.

The layered stack of function matrices 1203 to 1209 and 4405 transforms the user-defined distribution 1203 by processing it through the layered stack to define the transformed distribution 1210. Node functions in one or more layers 1203 to 1209 and 4405 are updated in response to user input signals 1211. The transformed distribution 1210 is supplied 4511 for audio signal distribution by the audio interface 101.

The audio interface 101 performs the role of an audio signal distributor by receiving the transformed distribution 1210 and distributing audio input samples 1301 to 1318 at step 4704 shown in FIG. 47. Audio signal distribution is performed with improved efficiency for the previously stated reasons. The musicians 109, 111 can monitor their performances while playing and recording with imperceptible audio latency on their headphones 108, 110, each of which receives a different customised mix. This arrangement ensures that professional quality recordings and performances can be made by the musicians 109, 111 using minimal equipment such as that shown in FIG. 1.

The invention claimed is:

1. A system for distributing audio signals from a plurality of audio inputs to a plurality of audio outputs, comprising:
an interface for generating user input signals in response to user input; and
one or more processors configured to distribute the audio signals from the audio inputs to the audio outputs in response to a user-defined distribution and a plurality of function matrices stored in memory of the one or more processors, each of the function matrices comprising a two-dimensional array of function nodes and each of the function matrices being a layer in a respective third dimension in a transforming stack of the function matrices, the one or more processors being configured to distribute the audio signals by:
a) establishing a transformed distribution by processing the user-defined distribution through the layers of the transforming stack;
b) receiving second user input signals for a requested change in distribution of the audio inputs to the audio outputs and identifying a modifying request in the second user input signals;
c) modifying at least one of the function matrices in response to the modifying request;
d) updating the transformed distribution by processing a gain factor through at least one layer of the transforming stack in response to the modification; and
e) distributing the audio signals from the audio inputs to the audio outputs in response to the updated transformed distribution.

2. The system of claim 1, wherein the one or more processors is configured for updating the transformed distribution by:
c1) propagating a changed condition through the transforming stack to the transformed distribution in response to the modification; and
c2) updating the transformed distribution by processing the gain factor through the at least one layer of the transforming stack in response to the propagated condition.

3. The system of claim 1, wherein the one or more processors is configured for modifying the at least one of the function matrices in response to the modifying request by activating one of the function matrices.

4. The system of claim 1, wherein the one or more processors is configured by at least one of the function matrices to reduce at least one dimension of the transforming stack.

5. The system of claim 1, wherein the one or more processors is configured by a first function matrix in a first layer of the transforming stack to reduce at least one dimension of the transforming stack by combining outputs from function nodes of a function matrix in a second layer of the transforming stack.

6. The system of claim 5, wherein the reducing of at least one dimension is performed by the one or more processors in response to a function matrix in a virtual bus-applying layer.

7. The system of claim 1, wherein the one or more processors is configured by at least one of the function matrices to modify distribution gains in response to a volume-adjusting layer in the transforming stack.

8. The system of claim 1, wherein the one or more processors is configured by at least one of the function matrices to serialise the transformed distribution.

9. The system of claim 3, wherein the one or more processors is configured by function nodes in an activated layer comprising the activated function matrix to mask a plurality of user-defined distribution gains.

10. The system of claim 3, wherein the one or more processors is configured by function nodes in an activated layer comprising the activated function matrix to re-route a plurality of input signals.

11. A method of distributing audio signals from a plurality of audio inputs to a plurality of audio outputs in response to a user-defined distribution and a plurality of function matrices, each of the function matrices comprising a two-dimensional array of function nodes and each of the function matrices being a layer in a respective third dimension in a transforming stack of the function matrices, the method comprising:
a) establishing a transformed distribution by processing the user-defined distribution through the layers of the transforming stack;
b) receiving user input signals for a requested change in distribution of the audio inputs to the audio outputs and identifying a modifying request in the user input signals;
c) modifying at least one of the function matrices in response to the modifying request;
d) updating the transformed distribution by processing a gain factor through at least one layer of the transforming stack in response to the modification; and
e) distributing the audio signals from the audio inputs to the audio outputs in response to the updated transformed distribution.

12. The method of claim 11, wherein the transformed distribution is updated by:
c1) propagating a changed condition through the transforming stack to the transformed distribution in response to the modification; and
c2) updating the transformed distribution by processing the gain factor through the at least one layer of the transforming stack in response to the propagated condition.

13. The method of claim 11, wherein the at least one of the function matrices is modified in response to the modifying request by activating one of the function matrices.

14. The method of claim 11, further comprising processing a plurality of distribution gains through a function matrix that reduces at least one dimension of the transforming stack.

15. The method of claim 11, further comprising processing a plurality of distribution gains through a function matrix in a first layer of the transforming stack to reduce at least one dimension of the transforming stack by combining outputs from function nodes of a function matrix in a second layer of the transforming stack.

16. The method of claim 15, wherein the reducing of at least one dimension is performed by a function matrix in a virtual bus-applying layer.

17. The method of claim 11, further comprising modifying distribution gains in response to a volume-adjusting layer in the transforming stack.

18. The method of claim 11, further including processing the transformed distribution through a serializing layer to serialise the transformed distribution.

19. The method of claim 13, wherein the modified function matrix is modified to mask a plurality of user-defined distribution gains.

20. A method of distributing audio signals from a plurality of audio inputs to a plurality of audio outputs in response to a layered stack of function matrices, each function matrix comprising a two-dimensional array of function nodes, comprising:
a) updating node functions in a layer of the layered stack in response to user input signals;
b) transforming a user-defined distribution by processing the user-defined distribution through the layered stack to define a transformed distribution; and
c) supplying the transformed distribution for audio signal distribution.
